(19) United States
(12) Patent Application Publication
(10) Pub. No.: US 2025/0014462 A1
(43) Pub. Date: Jan. 9, 2025

(54) TRAFFIC MANAGEMENT SYSTEMS AND METHODS

(71) Applicants: AMIR HOSEIN GHODS, OTTAWA (CA); AMIR REZA GHODS, MANOTICK (CA)

(72) Inventors: AMIR HOSEIN GHODS, OTTAWA (CA); AMIR REZA GHODS, MANOTICK (CA)

(21) Appl. No.: 18/712,458

(22) PCT Filed: Nov. 22, 2022
(86) PCT No.: PCT/CA2022/051715

§ 371 Date: May 22, 2024

Related U.S. Application Data
(60) Provisional application No. 63/264,452, filed on Nov. 23, 2021.

(51) Int. Cl. G08G 1/01; G08G 1/052; G08G 1/08

(52) U.S. Cl. CPC G08G 1/0145; G08G 1/0133; G08G 1/052; G08G 1/08

(57) ABSTRACT

Simple traffic management strategies such as static signs, fixed pattern timed traffic lights, etc. fail to address the dynamic nature of traffic flow resulting in traffic backups and inefficiency. Accordingly, there are provided means for dynamically adjusting traffic signs, traffic signals etc. to adjust the flow to remove backups, avoid tailbacks and increase efficiency of travel etc. Further, most control systems are controlled with default control settings or ones based upon limited information. Accordingly, there are provided methods based upon real-time or offline micro-simulations from enhanced information and acquired data accumulated at high frequency, such as from connected vehicles, to allow for improved evolving model(s) of traffic flow within the traffic system to be established for establishing control settings etc. of traffic infrastructure such as traffic signs, traffic signals etc.

### CROSS-REFERENCE TO RELATED APPLICATIONS

This patent application claims the benefit of priority to World Intellectual Property Organization PCT/CA2022/051715 filed Nov. 22, 2022; which itself claims the benefit of priority to U.S. Provisional Patent Application 63/264,452 filed Nov. 23, 2021; the entire contents of each being incorporated herein by reference.

### FIELD OF THE INVENTION

This patent application relates to traffic management and more particularly to methods and systems for acquiring and analysing vehicle related data, such as probe and/or connected vehicle data, to establish static or dynamic control schedules and control schedule adjustments for traffic control, traffic infrastructure analysis, and road safety analysis.

### BACKGROUND OF THE INVENTION

Across the world the flow of traffic moving along intersecting roads is controlled through physical means and their associated rules, such as traffic signs, speed signs, roundabouts etc. or through signals and their associated rules, such as traffic lights, so that the traffic flow is controlled. This avoids conflicts at intersections and traffic merging areas and reduces the inefficiencies that arise uncontrolled or minimally controlled traffic flow.

However, simple traffic management strategies such as static signs, fixed pattern timed traffic lights, and alike general fail to address the dynamic nature of traffic flow, such as changes to traffic volume for a given trafficway over time, resulting in traffic backups and general inefficiency. Accordingly, it would be beneficial to provide a means of dynamically adjusting traffic signs, traffic signals etc. to adjust the flow to remove backups, avoid tailbacks and increase efficiency of travel etc. However, prior art approaches to monitoring have been infrastructure based with loop detectors, cameras, radar etc. which is expensive and only effective where installed. It would be beneficial to provide traffic system designers and traffic system operators with enhanced information across the entire traffic system in real-time or near real-time allowing improved monitoring, dynamic control of traffic signs, traffic lights, etc.

Conventional signaling systems with or without augmentation with sensors, timing controls, etc. to provide some limited dynamics are defined by the underlying timing, calendaring etc. installed within the signaling system. Accordingly, within the prior art periodic assessments of junctions and traffic flows are employed to assess the bottlenecks and efficiencies resulting from the current control settings. Such, assessments are time consuming, irregular, and tend to only cover a small fraction of the junctions, road sections etc. Accordingly, most control systems are controlled with control settings that are default settings or are defined based upon limited information. Accordingly, to provide traffic system designers and traffic system operators with enhanced information across the entire traffic system accumulated at high frequency allowing improved evolving model(s) of traffic flow within the traffic system to be established for establishing control settings etc. of traffic infrastructure such as traffic signs, traffic signals etc.

Other aspects and features of the present invention will become apparent to those ordinarily skilled in the art upon review of the following description of specific embodiments of the invention in conjunction with the accompanying figures.

### SUMMARY OF THE INVENTION

It is an objective of the present invention to mitigate limitations within the prior art relating to traffic management and more particularly to methods and systems for acquiring and analysing vehicle related data, such as probe and/or connected vehicle data, to establish static or dynamic control schedules and control schedule adjustments for traffic control, traffic infrastructure analysis, and road safety analysis.

In accordance with an embodiment of the invention there is provided a method comprising: acquiring connected vehicle location data;
processing the acquired connected vehicle location data to establish one or more performance measures with respect to at least one of a road segment and a traffic junction; and
establishing in dependence upon the performance measures and current traffic signal timing of one or more traffic signals for the at least one of the road segment and the traffic junction a modification to the current traffic signal timing of the one or more traffic signals.

In accordance with an embodiment of the invention there is provided a method comprising:
a) acquiring location data from one or more connected vehicles associated with a section of a highway at a defined frequency of acquisition;
b) generating a performance metric in dependence upon the location data where the performance metric is a travel time or a speed;
c) making a first determination as to whether the travel time exceeds a travel time threshold when the performance metric is the travel time
d) making a second determination as to whether the speed exceeds a speed threshold when the performance metric is the speed;
e) generating a trigger in dependence upon the first determination and the second determination;
f) adjusting one or more traffic signals to a new setting from an original setting in dependence upon the trigger;
g) repeating steps (a) to (d) and adjusting the one or more traffic signals from the new setting back to the original setting in dependence upon the trigger not being generated.

In accordance with an embodiment of the invention there is provided a method comprising: acquiring connected vehicle location data;
processing the acquired connected vehicle location data to establish one or more performance measures with respect to a traffic junction; and
establishing in dependence upon the performance measures at least one of the presence of a faulty detector associated with the traffic junction and a failure in the signal timing settings for the traffic junction.

In accordance with another embodiment of the invention there is provided a method comprising:
acquiring high-resolution connected vehicle location data;
processing the acquired high-resolution connected vehicle location data to establish a performance measure with respect to a traffic signal; wherein
the performance measure is either:
   a first measure relating to an overall performance measure of the traffic signal; or
   a second measure relating to an indication of an improvement with respect to a current overall performance measure of the traffic signal upon establishing a re-timing of the traffic signal.

In accordance with an embodiment of the invention there is provided a method comprising:
a) acquiring location data from one or more connected vehicles associated with a highway ramp and a highway associated with the highway ramp at a defined frequency of acquisition;
b) generating a performance metric in dependence upon the location data where the performance metric is at least one of a ramp travel time and a ramp queue speed;
c) convert the at least one of the travel time and the speed to a queue length for the highway ramp and a traffic density for the highway;
d) adjusting a metering signal rate of one or more traffic signals associated with the highway ramp in dependence upon the traffic density;
c) making a first determination as to whether the ramp travel time exceeds a travel time threshold when the performance metric is the ramp travel time
d) making a second determination as to whether the ramp queue speed exceeds a queue speed threshold when the performance metric is the ramp queue speed;
e) generating a trigger in dependence upon the first determination and the second determination;
f) adjusting one or more other traffic signals associated with the highway ramp to a new setting from an original setting in dependence upon the trigger and iterating the adjustments to return the at least one of a ramp travel time and a ramp queue speed below their respective travel time threshold and travel speed threshold; wherein the at least one of a travel time and a speed are established for a plurality of segments of a road network comprising the highway ramp;
each segment of the plurality of segments is defined by a portion of the road network from a first location prior to the highway ramp to a second location after the highway ramp;
the ramp travel time is established in dependence upon a time from a third location to a fourth location where the third location and the fourth location are defined with respect to the ramp; and
the ramp queue speed is established in dependence upon an average speed from a fifth location to a sixth location where the fifth location and the sixth location are defined with respect to the ramp.

In accordance with an embodiment of the invention there is provided a method comprising:
the acquired connected vehicle data comprises location data and at least one of accelerometer data, velocity data and sensor data associated with a sensor forming part of an element of protecting an individual; and
the process comprises:
   determining when the at least one of the accelerometer data, the velocity data and the sensor data to establish an event of a plurality of events associated with a connected vehicle and a time stamp associated with the event of the plurality of events;
   upon a positive determination of the event parsing the location data within the acquired connected vehicle data having the time stamp with respect to a database comprising data relating to a portion of a road network to establish at least one of a road segment within the road segment within the road network, an intersection within the road network and a turning movement at another intersection at which the event occurred.

In accordance with the embodiment of the invention the method may further comprise ranking the established at least one of the road segments within the road network, the intersections within the road network, the another intersections and the turning movements for the events of the plurality of events occurred.

In accordance with an embodiment of the invention there is provided a method comprising: acquiring connected vehicle data comprises location data and at least one of accelerometer data, velocity data and sensor data associated with a sensor forming part of an element of protecting an individual;
determining when the at least one of the accelerometer data, the velocity data and the sensor data to establish an event of a plurality of events associated with a connected vehicle and a time stamp associated with the event of the plurality of events;
upon a positive determination of the event parsing the location data within the acquired connected vehicle data having the time stamp with respect to a database comprising data relating to a portion of a road network to establish at least one of a road segment within the road network, an intersection within the road network and a turning movement at another intersection at which the event occurred;
parsing the acquired connected vehicle data and other network data associated with the at least one of the road segment within the road network and the intersection within the road network at which an event of the plurality of events occurred to establish a dataset comprising at least one of:
   a volume of traffic associated with the road segment within the at least one of the road network, the intersection and the another intersection at which the event of the plurality of events occurred;
   a speed of the connected vehicle associated with the event of the plurality of events; and
   a portion of the other network data associated with the event of the plurality of events; and
employing the dataset as a training set to at least one of an artificial intelligence process and a machine learning process to establish an event prediction model.

In accordance with the embodiment of the invention the other network data comprises at least one:
acquired connected vehicle data associated with other connected vehicles associated with the at least one of the road segment within the road network and an intersection within the road network at which an event of the plurality of events occurred within a predetermined time period of the time stamp of the event of the plurality of events; and
network infrastructure data relating to one or more active elements of infrastructure controlling traffic for the at least one of the road segment within the road network and the intersection within the road network at which an event of the plurality of events occurred within a predetermined time period of the time stamp of the event of the plurality of events.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary network environment within which devices, systems and methods according to and supporting embodiments of the invention may be deployed and operate; and

FIG. 2 depicts an exemplary wireless portable electronic device supporting communications to a network such as depicted in FIG. 1 and devices, systems and methods according to and supporting embodiments of the invention may be deployed and operate;

FIG. 3 depicts an example of a highway junction to which embodiments of the invention may be applied based upon acquiring data from connected vehicles and processing with systems according to embodiments of the invention;

FIG. 4 depicts an exemplary flow chart for a traffic management system (TMS) according to an embodiment of the invention for adjusting traffic signal timing to improve safety and mobility at a highway off-ramp;

FIG. 5 depicts an exemplary flow chart for a traffic management system (TMS) according to an embodiment of the invention for optimizing a traffic simulation and adjusting traffic signal timing accordingly;

FIG. 6 depicts an exemplary flow chart for a traffic management system (TMS) according to an embodiment of the invention for adjusting traffic signal timing to improve safety and mobility at a highway off-ramp;

FIG. 7 depicts an exemplary flow chart for a traffic management system (TMS) according to an embodiment of the invention for optimizing a traffic simulation and adjusting traffic signal timing accordingly;

FIG. 8 depicts an exemplary flow chart for a traffic management system (TMS) according to an embodiment of the invention for optimizing a traffic simulation and adjusting traffic signal timing accordingly;

FIG. 9 depicts an exemplary flow chart for a traffic management system (TMS) according to an embodiment of the invention for capturing faulty traffic management detectors and/or sub-poor signal timing settings;

FIGS. 10 and 11 depict exemplary analytics from a TMS according to an embodiment of the invention with respect for traffic intersections controlled by traffic signals using data established from connected vehicles;

FIGS. 12A to 12C depict exemplary analytics from a TMS according to an embodiment of the invention with respect for traffic conditions on a traffic corridor using data established from connected vehicles;

FIG. 13A and FIG. 13B depict the impact of adjustments to traffic signals based upon analytics of data established from connected vehicles by a system according to an embodiment of the invention with respect to average speed and average travel time for a route before and after adjustment of traffic signals along the route;

FIGS. 14 to 16B depict graphical user interfaces within a software application according to an embodiment of the invention presented to a user based upon analytics of data established from connected vehicles with respect to connected vehicle actions such as speeding, hard acceleration and hard breaking; and

FIG. 17 depicts analytical data from a TMS according to an embodiment of the invention with respect to triggering alerts and/or dynamic adjustments for a route exploiting analytics of data established from connected vehicles.

### DETAILED DESCRIPTION

The present invention is directed to traffic management and more particularly to methods and systems for acquiring and analysing vehicle related data, such as probe and/or connected vehicle data, to establish static or dynamic control schedules and control schedule adjustments for traffic control, traffic infrastructure analysis, and road safety analysis

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “wireless standard” as used herein and throughout this disclosure refers to, but is not limited to, a standard for transmitting signals and/or data through electromagnetic radiation which may be optical, radio frequency (RF) or microwave although typically RF wireless systems and techniques dominate. A wireless standard may be defined globally, nationally, or specific to an equipment manufacturer or set of equipment manufacturers. Dominant RF wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella. Microwave communications may be supported upon microwave signals within a defined frequency range permitted by the jurisdiction(s) the system currently operates within either licensed or unlicensed such as within L, S, C, X, Ku, K, Ka, V and W bands or millimeter band. Such microwave communications may be terrestrial or satellite communications.

A “wired standard” as used herein and throughout this disclosure refers to, but is not limited to, a standard for transmitting signals and/or data through a cable discretely or in combination with another signal. Electrical wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “user” as used herein and throughout this disclosure refers to, but is not limited to, an individual or group of individuals. This includes, private individuals, employees of organizations and/or enterprises, members of community organizations, members of charity organizations, men, women and children. In its broadest sense the user may further include, but not be limited to, mechanical systems, robotic systems, android systems, etc. that may be characterised by an ability to exploit one or more embodiments of the invention.

A “sensor” as used herein and throughout this disclosure refers to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

“Traffic infrastructure” as used herein and throughout this disclosure refers to, but is not limited to, an element permanently, semi-permanently or temporarily disposed with respect to a transportation network, transportation system or transportation route. Traffic infrastructure may include, not be limited to, traffic signs, traffic lights, traffic barriers, traffic calming elements, road surface markers, cabinets for electrical and/or electronic equipment associated with a transportation route, bus shelters, bus stops, and kerbs.

A “vehicle” as used herein and throughout this disclosure refers to, but is not limited to, a power or unpowered machine that transports people or cargo. A vehicle may include, but not be limited to, a wagon, a bicycle, a motorcycle, a motorcar (car), a truck, a bus) and a bus with respect to vehicles having freedom of motion upon terrain. However, a vehicle may also include railed vehicles (e.g. trains, trams), watercraft (e.g. ships, boats), amphibious vehicles (e.g. screw-propelled vehicle, hovercraft), and aircraft (e.g. airplanes, helicopters, aerostat) without departing from the scope of the invention. A vehicle may be controlled by a user, be autonomous (commonly referred to a self-driving) or semi-autonomous (capable of both user controlled and autonomous modes or provide driver assistance features).

A “connected vehicle” (CV) as used herein and throughout this disclosure refers to, but is not limited to, a vehicle with one or more wireless interfaces and/or one or more wired interfaces to receive and/or transmit data from/to another vehicle and/or a communications network and/or roadside infrastructure. These wireless and/or wired interfaces may be integral to the vehicle or they may be temporarily associated with the user such as through a PED of an occupant of the vehicle, a PED associated with cargo within the vehicle, a PED associated with the driver of the vehicle, etc.

A “portable electronic device” (PED) as used herein and throughout this disclosure refers to, but is not limited to, a wireless device used for communications and other applications that requires a battery or other independent form of energy for power. This includes devices, but is not limited to, such as a vehicle, a connected vehicle, a cellular telephone, a smartphone, a personal digital assistant (PDA), a portable computer, a pager, a portable multimedia player, a portable gaming console, a laptop computer, a tablet computer, a wearable device and an electronic reader.

A “fixed electronic device” (FED) as used herein and throughout this disclosure refers to, but is not limited to, a wireless and/or wired device used for communications and other applications that requires connection to a fixed interface to obtain power. This includes, but is not limited to, an element of traffic infrastructure, a laptop computer, a personal computer, a computer server, a kiosk, a gaming console, a digital set-top box, an analog set-top box, an Internet enabled appliance, an Internet enabled television, and a multimedia player.

A “server” as used herein and throughout this disclosure refers to, but is not limited to, one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein and throughout this disclosure refers to, but is not limited to, a “software application,” an element of a “software suite,” a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein and throughout this disclosure refers to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein and throughout this disclosure refers to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein and throughout this disclosure refers to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein and throughout this disclosure refers to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

“Biometric” information as used herein and throughout this disclosure refers to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“User information” as used herein and throughout this disclosure refers to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” as used herein and throughout this disclosure refers to, but is not limited to, miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein and throughout this disclosure refers to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example. Within a broader approach digital content may include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein and throughout this disclosure refers to, but is not limited to, a computer and/or microprocessor readable data file comprising data relating to settings and/or limits of an adult device. Such profiles may be established by a manufacturer/supplier/provider of a device, service, etc. or they may be established by a user through a user interface for a device, a service or a PED/FED in communication with a device, another device, a server or a service provider etc.

A “computer file” (commonly known as a file) as used herein and throughout this disclosure refers to, but is not limited to, to a computer resource for recording data discretely in a computer storage device, this data being electronic content. A file may be defined by one of different types of computer files, designed for different purposes. A file may be designed to store electronic content such as a written message, a video, a computer program, or a wide variety of other kinds of data. Some types of files can store several types of information at once. A file can be opened, read, modified, copied, and closed with one or more software applications an arbitrary number of times. Typically, files are organized in a file system which can be used on numerous different types of storage device exploiting different kinds of media which keeps track of where the files are located on the storage device(s) and enables user access. The format of a file is defined by its content since a file is solely a container for data, although, on some platforms the format is usually indicated by its filename extension, specifying the rules for how the bytes must be organized and interpreted meaningfully. For example, the bytes of a plain text file are associated with either ASCII or UTF-8 characters, while the bytes of image, video, and audio files are interpreted otherwise. Some file types also allocate a few bytes for metadata, which allows a file to carry some basic information about itself.

“Metadata” as used herein and throughout this disclosure refers to, but is not limited to, information stored as data that provides information about other data. Many distinct types of metadata exist, including but not limited to, descriptive metadata, structural metadata, administrative metadata, reference metadata and statistical metadata. Descriptive metadata may describe a resource for purposes such as discovery and identification and may include, but not be limited to, elements such as title, abstract, author, and keywords. Structural metadata relates to containers of data and indicates how compound objects are assembled and may include, but not be limited to, how pages are ordered to form chapters, and typically describes the types, versions, relationships and other characteristics of digital materials. Administrative metadata may provide information employed in managing a resource and may include, but not be limited to, when and how it was created, file type, technical information, and who can access it. Reference metadata may describe the contents and quality of statistical data whereas statistical metadata may also describe processes that collect, process, or produce statistical data. Statistical metadata may also be referred to as process data.

An “artificial intelligence system” (referred to hereafter as artificial intelligence, AI) as used herein and throughout this disclosure refers to, but is not limited to, refers to machine intelligence or machine learning in contrast to natural intelligence. An Al may refer to analytical, human inspired, or humanized artificial intelligence. An Al may refer to the use of one or more machine learning algorithms and/or processes. An AI may employ one or more of an artificial network, decision trees, support vector machines, Bayesian networks, and genetic algorithms. An Al may employ a training model or federated learning.

“Machine Learning” (ML) or more specifically machine learning processes as used herein and throughout this disclosure refers to, but is not limited to, programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an Al may include, but not be limited to, supervised learning, unsupervised learning, cluster analysis, reinforcement learning, feature learning, sparse dictionary learning, anomaly detection, association rule learning, inductive logic programming.

A “geolocation” (also known as a geoposition or simply location) as used herein and throughout this disclosure refers to, but is not limited to, a set of geographic coordinates or coordinates which define an objects position either globally or locally with respect to a datum. A geolocation may be established using one or more techniques including, but not limited to, a global positioning system, a satellite navigation system, optical triangulation, wireless triangulation, and gyroscopic means.

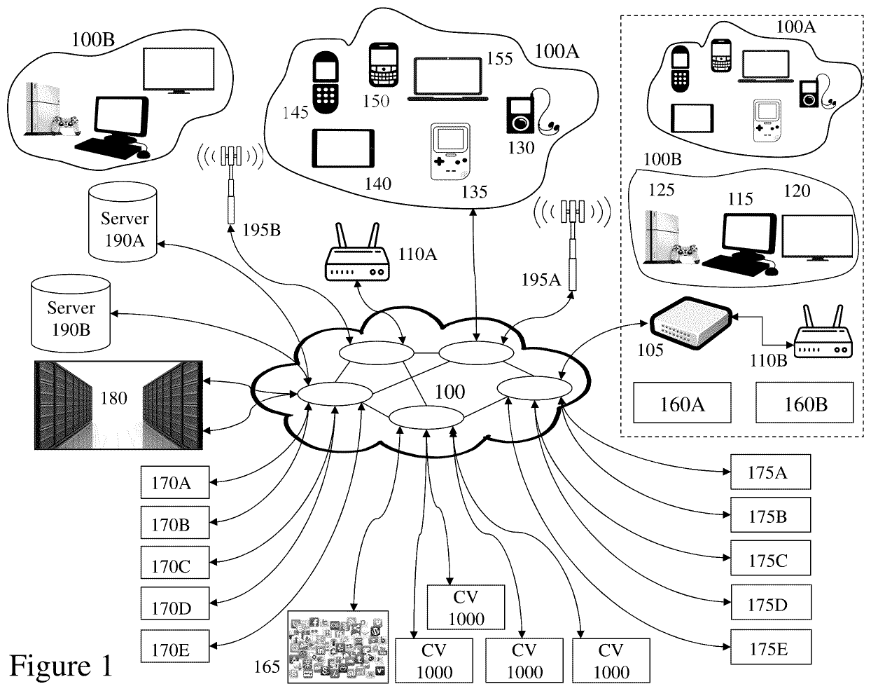

Referring to FIG. 1 there is depicted a Network 100 within which embodiments of the invention may be employed supporting Connected Vehicle (CV) Systems, Applications and Platforms (CV-SAPs) according to embodiments of the invention. Such CV-SAPs, for example, supporting multiple communication channels, dynamic filtering, etc. As shown first and second user groups 100A and 100B respectively interface to a telecommunications Network 100. Within the representative telecommunication architecture, a remote central exchange 180 communicates with the remainder of a telecommunication service providers network via the Network 100 which may include for example long-haul OC-48/OC-192 backbone elements, an OC-48 wide area network (WAN), a Passive Optical Network, and a Wireless Link. The central exchange 180 is connected via the Network 100 to local, regional, and international exchanges (not shown for clarity) and therein through Network 100 to first and second cellular APs 195A and 195B respectively which provide Wi-Fi cells for first and second user groups 100A and 100B respectively. Also connected to the Network 100 are first and second Wi-Fi nodes 110A and 110B, the latter of which being coupled to Network 100 via router 105. Second Wi-Fi node 110B is associated with Enterprise 160 comprising other first and second user groups 100A and 100B. Second user group 100B may also be connected to the Network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the Network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the Network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations cither through standards such as IEEE 802.15 or Bluetooth as well in an ad-hoc manner.

Also connected to the Network 100 are Social Networks (SOCNETS) 165, first and second service providers 170A and 170B respectively, first and second third party service providers 170C and 170D respectively, and a user 170E. Also connected to the Network 100 are first and second enterprises 175A and 175B respectively, first and second organizations 175C and 175D respectively, and a government entity 175E. Also depicted are first and second servers 190A and 190B may host according to embodiments of the inventions multiple services associated with a provider of contact management systems and contact management applications/platforms (CV-SAPs); a provider of a SOCNET or Social Media (SOME) exploiting CV-SAP features; a provider of a SOCNET and/or SOME not exploiting CV-SAP features; a provider of services to PEDS and/or FEDS; a provider of one or more aspects of wired and/or wireless communications; an Enterprise 160 exploiting CV-SAP features; license databases; content databases; image databases; content libraries; customer databases; websites; and software applications for download to or access by FEDs and/or PEDs exploiting and/or hosting CV-SAP features. First and second primary content servers 190A and 190B may also host for example other Internet services such as a search engine, financial services, third party applications and other Internet based services.

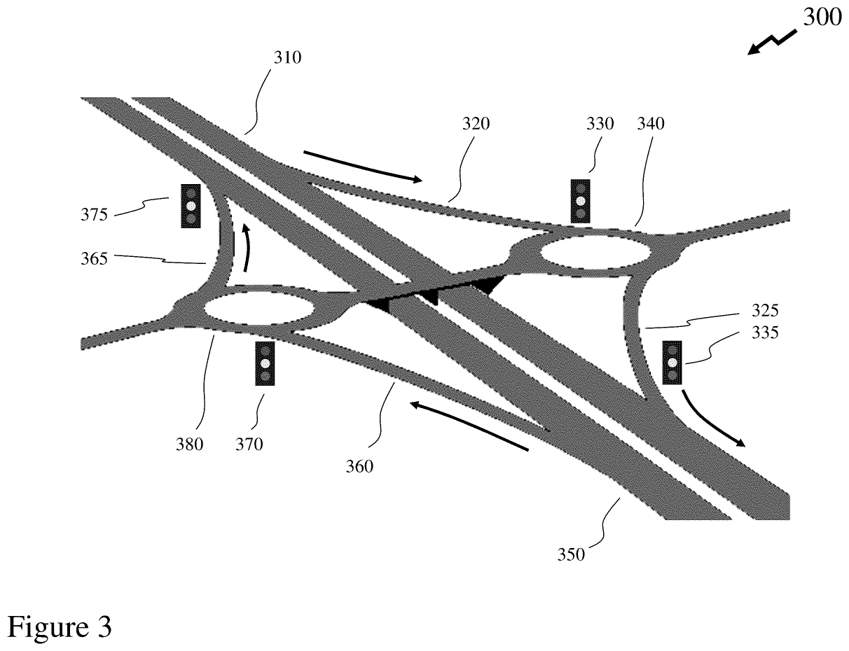

Also depicted in FIG. 1 are Connected Vehicles (CVs) 1000 according to embodiments of the invention such as described and depicted below in respect of FIGS. 3A to XXX. As depicted in FIG. 1 the CVs 1000 communicate directly to the Network 100. The CVs 1000 may communicate to the Network 100 through one or more wireless or wired interfaces included those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides CV-SAP features according to embodiments of the invention; execute an application already installed providing CV-SAP features; execute a web based application providing CV-SAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A. It would also be evident that a CONCUS may, via exploiting Network 100 communicate via telephone, fax, email, SMS, social media, etc.

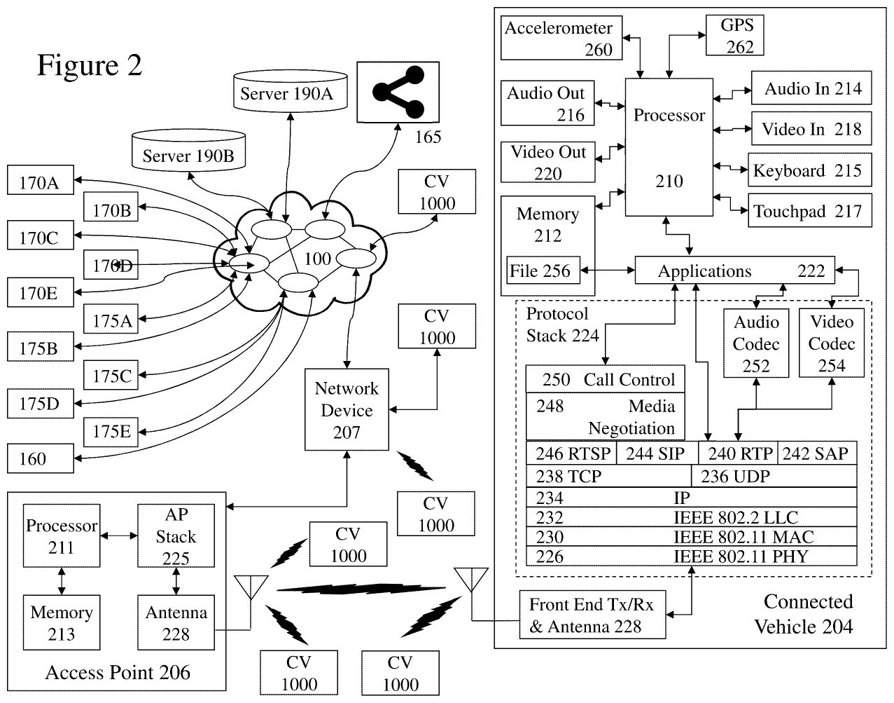

Now referring to FIG. 2 there is depicted a Connected Vehicle 204 and network access point 207 supporting CV-SAP features according to embodiments of the invention. Connected Vehicle 204 may, for example, be a PED and/or FED and may include additional elements beyond those described and depicted. Also depicted within the Connected Vehicle 204 is the protocol architecture as part of a simplified functional diagram of a system 200 that includes a Connected Vehicle 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to Network 100 and therein Social Networks (SOCNETS) 165, first and second service providers 170A and 170B respectively, first and second third party service providers 170C and 170D respectively, a user 170E, first and second enterprises 175A and 175B respectively, first and second organizations 175C and 175D respectively, and a government entity 175E.

The Connected Vehicle 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Connected Vehicle 204 may include an audio input element 214, for example a microphone, and an audio output element 216, for example, a speaker, coupled to any of processors 210. Connected Vehicle 204 may include a video input element 218, for example, a video camera or camera, and a video output element 220, for example an LCD display, coupled to any of processors 210. Connected Vehicle 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Connected Vehicle 204. The one or more applications 222 that are typically stored in memory 212 and are executable by any combination of processors 210. Connected Vehicle 204 also includes accelerometer 260 providing three-dimensional motion input to the process 210 and GPS 262 which provides geographical location information to processor 210.

Connected Vehicle 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the Connected Vehicle 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by Connected Vehicle 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted in FIG. 2 are Connected Vehicles (CVs) 0100 according to embodiments of the invention such as described and depicted below in respect of FIGS. 3A to XXX. As depicted in FIG. 2 the CVs 1000 may communicate directly to the Network 100. Other CVs 1000 may communicate to the Network Device 207, Access Point 206, and Electronic Device 204. Some CVs 1000 may communicate to other CVs 1000 directly. Within FIG. 2 the CVs 1000 coupled to the Network 100 and Network Device 207 communicate via wired interfaces. The CVs 1000 coupled to the Access Point 206 and Electronic Device 204 communicate via wireless interfaces. Each IRED 100 may communicate to another electronic device, e.g. Access Point 206, Electronic Device 204 and Network Device 207, or a network, e.g. Network 100. Each IRED 100 may support one or more wireless or wired interfaces including those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED, wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the Network 100 using the electronic device or within either the access point 206 or network device 207 wherein details of the transaction are then coupled to the Network 100 and stored within remote servers.

Optionally, rather than wired and/or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH) etc.

Within the following description and with reference to the Figures SYSTEM MAY MEAN SOFTWARE/EXECUTABLE CODE

Within the following embodiments of the invention as described and depicted with respect to FIGS. 3-5 respectively reference is made to connected vehicles, probe vehicles and data acquired from either connected vehicles and/or probe vehicles. A connected vehicle as defined above is a vehicle with one or more wireless interfaces and/or one or more wired interfaces to receive and/or transmit data from/to another vehicle and/or a communications network. The communications network may be accessed such as through wireless infrastructure or a roadside cabinet or unit for example. The connected vehicle may acquire the data directly from one or more systems of the vehicle or it may derive the data from data acquired by the systems of the vehicle.

Within an embodiment of the invention a connected vehicle may provide vehicle-to-vehicle and vehicle-to-network communications of data relating to the vehicle, such as location, speed, direction, time, number of occupants etc. Some connected vehicles may support only vehicle-to-vehicle data communications whilst others may support vehicle-to-vehicle and vehicle-to-network communications or just vehicle-to-network communications.

Within the following embodiments of the invention as described and depicted with respect to FIGS. 3-5 respectively reference is made to connected vehicle data. The methods and systems as described and depicted may integrate other data sources with the connected vehicle data in order to provide the overall data set for analysis, modelling, simulation, decision making etc. Whilst these are not described specifically in each instance the embodiments of the invention described and depicted with respect to FIGS. 3-5 respectively my operate with these other data sources and within their broadest scope support connected vehicle data and/or other data sources.

Another data source may be crowdsourced data which is timestamped location and speed data received from moving vehicles whether connected vehicles or not. The location data can be sourced from onboard vehicle GPS system or mobile applications for example. Crowdsourced travel time data allows for traffic data acquisition for more roads and locations, eliminating the installation of physical sensors for some applications.

Another data source may include a roadside radar. For example, the roadside radar may be a Smartmicro™ radar employing multiple forward beams so that vehicles can be tracked over a defined distance and/or field of view (FOV) (e.g. for up to 300 metres and over a 100-degree fOV) such that vehicles are inside the field of view for an extended time allowing vehicle position and speed vectors to be measured with higher accuracy.

Another data source may include a roadside scanner such as the TrafficBox™, TrafficXHub™ and TrafficXHub™ Cabinet devices from SMATS Traffic Solutions which incorporate wireless scanner(s) (e.g., Wi-Fi and Bluetooth scanners) to provide media access control (MAC) address detection and matching to identify connected vehicles and/or PEDs associated with occupants/drivers of vehicles whether connected vehicles or not. Such scanners may upload acquired data in real time to cloud based storage or may store and periodically transmit the acquired data to the cloud based storage.

It would be evident to one of skill in the art that the embodiments of the invention may process data acquired from other sources including, but not limited to, hardware based modules for establishing one or more characteristics of one or more vehicles, and software-based modules such as network control databases, algorithms, etc.

Now referring to FIG. 3 there is depicted a Junction 300 to which embodiments of the invention may be applied. As depicted the Junction 300 comprises a first Lane 310 which has a first Slip Road 320 feeding off it as part of a junction to a first Junction Section 340 where a first Traffic Light 330 controls traffic flow from the first Slip Road 320 to the first Junction Section 340. The Junction 300 also comprises a second Lane 350 which has a second Slip Road 360 feeding off it as part of a junction to a second Junction Section 380 where a second Traffic Light 370 controls traffic flow from the second Slip Road 360 to the second Junction Section 380.

It would be evident that if the volume of traffic exiting, for example, the first Lane 310 via the first Slip Road 320 increases then a threshold volume is reached where more vehicles are coming onto the first Slip Road 320 than exit it to the first Junction Section 340 through the timing of the first Traffic Light 330. This results in traffic backing up down the first Slip Road 320 However, a default adjustment to the timing of the first Traffic Light 330 to allow increased traffic from the first Slip Road 320 to proceed impacts traffic flow through the first Junction Element 340 for traffic that has not come off the first Lane 310. Accordingly, it would be beneficial to dynamically adjust the settings of the first Traffic Light 330 to allow increased traffic from the first Slip Road 320 to proceed to avoid a tailback onto the first Lane 310 even though this may impact traffic flow through the first Junction Element 340.

The first Slip Road 320 and second Slip Road 360 are also known as off-ramps when the traffic exits the first Lane 310 and second Lane 350 respectively. Third Slip Road 325 and fourth Slip Road 365 when the traffic joins the first Lane 310 and second Lane 350 respectively are also known as an on-ramps.

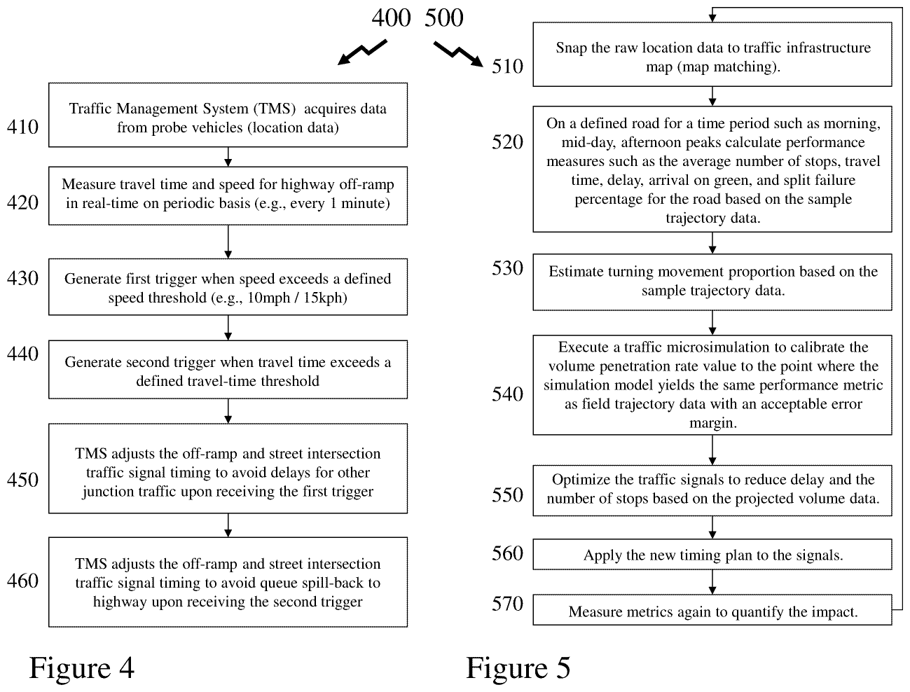

Accordingly, within an embodiment of the invention a traffic management system may execute an off-ramp queue control using traffic data from probe vehicles, connected vehicles, with a process as depicted in FIG. 4 with Flow 400 comprising first to sixth steps 410 to 460 respectively, these comprising:
First step 410 wherein the Traffic Management System (TMS) acquires data (e.g. location data, velocity, brake setting) from probe vehicles (e.g. connected vehicles);
Second step 420 wherein the TMS establishes from the acquired probe vehicle data a travel time and speed for the probe vehicles on a periodic basis, e.g. every minute;
Third step 430 wherein the TMS determines whether to generate a first trigger when the probe vehicle data indicates a speed exceeding a defined speed threshold (i.e. the traffic is moving well) where this threshold may for example be 10 mph or 15 kmh or another value defined in dependence upon one or more characteristics such as junction design, off-ramp length, etc.;
Fourth step 440 wherein the TMS determines whether to generate a second trigger when the probe vehicle data indicates a travel time for the probe vehicles exceeds a defined travel time threshold where this threshold may for example be 3 minutes, 5 minutes, or other value defined in dependence upon one or more characteristics such as junction design, off-ramp length, current light timing, etc.;
Fifth step 450 wherein the TMS adjusts the off-ramp and street intersection traffic signal timing to avoid delays for other junction traffic upon receiving the first trigger as well moving traffic on the off-ramp indicates it clearing well (for example); and
Sixth step 460 wherein the TMS adjusts the off-ramp and street intersection traffic signal timing to avoid queue spill-back to highway upon receiving the second trigger as excessive time to clear the off-ramp indicates that a backup may subsequently occur onto the highway.

The TMS may signal these changes to the traffic signals at the off-ramp and Junction 300 either through direct communication with them or through an application programming interface (API) to other systems that control the signals, such as an Advanced Traffic Management System (ATMS) etc. Optionally, these triggers can also be communicated to other TMS, ATMS etc. to provide additional data such as allowing the TMS to know that for one off-ramp on the highway the traffic signals for the other side are being adjusted as these adjustments impact the off-ramp where two off-ramps are associated with the same junction.

It would be evident that the TMS associated with a junction, such as Junction 300, may analyse probe vehicle data for other portions of the junction such as third Slip Road 325 in combination with first Lane 310 and/or fourth Slip Road 365 in combination with second Lane 350 such that the TMS can adjust the timing of the third Traffic Light 335 on the third Slip Road 325 for first Lane 310 and/or fourth Traffic Light 375 on the fourth Slip Road 365 for the second Lane 360 such that traffic onto these lanes is controlled to adjust the volume of traffic being allowed to join the lane or lanes with the intended aim of minimizing a reduction in traffic flowing past the Junction 300 on the highway comprising first Lane 310 and/or second Lane 350.

It would be evident that the periodicity of the second step 420 may be at other defined intervals or upon defined intervals that vary with time, day, month, etc. (e.g. high frequency of determinations during 6 am-11 pm and lower frequency 11 pm-6 am; high frequency during 6 am-9 am and 3 pm-6 pm for commuter traffic with lower frequency 9 am-3 μm and 6 pm-11 pm with another lower frequency 11 pm-6 am; etc.). Optionally, the periodicity may be established in dependence of the established data so that slower moving traffic on the off-ramp requires higher frequency analysis than faster moving traffic on the off-ramp. Optionally, the periodicity may be established in dependence upon weather to factor for varying driving conditions.

Optionally, the data acquired from the probe vehicle may include other data relating to the type of vehicle of the probe vehicle or other vehicles that the probe vehicle has acquired and is providing to the TMS. For example, a determination that the vehicles on the off-ramp includes one or more heave duty trucks, tankers or transporters may cause a temporary adjustment to the timing of the signal(s) the TMS is controlling as the time taken for such vehicles to get moving is increased and clearing such vehicles from the off-ramp allows larger number of other vehicles to use the off-ramp and/or exit through the signals subsequently as they are not slowed/blocked by the slower heavier moving truck(s), tanker(s), transporter(s) etc.

Whilst FIG. 4 is described and depicted with respect to an off-ramp it would be evident that the methods, processes and concepts may be applied to an on-ramp or other aspect of a portion of a traffic network. In such alternate applications one or more triggers may be generated upon monitored conditions dropping below one or more thresholds rather than exceeding them or a combination of exceeding/dropping below.

Now referring to FIG. 5 there is depicted a Flow 500 relating to the use of high-resolution connected vehicle location data to retime traffic signals comprising first to seventh steps 510 to 570 respectively, these comprising:
First step 510 wherein a Traffic Management Simulation System (TMSS) processes acquired location data, e.g. raw GPS data, to a traffic infrastructure map, e.g. a map managed by a regulatory authority, council, state, Government organization (e.g. Ordnance Survey in the UK), or a third-party service provider (e.g. OpenStreetMap™, Google™) in order to align the raw location data to the traffic infrastructure (what the inventors refer to as map matching);
Second step 520 wherein for a defined road for a defined time period such as morning peak, mid-morning peak, afternoon peak the TMSS calculates performance measures such the average number of stops, average travel time, average delay, number of arrivals on green, and split failure percentage for the road based on the sample trajectory data;
Third step 530 wherein the TMSS generates an estimate of a turning movement proportion based on the sample trajectory data for the junction;
Fourth step 540 wherein the TMSS executes a traffic microsimulation (TuS) to calibrate the volume penetration rate value to the point where the simulation model (SIMOD) yields a performance metric with an acceptable error margin of the field trajectory data defined from the connected vehicle data;
Fifth step 550 wherein the TMSS executes an optimisation process for the control data for traffic signals associated with the defined road to reduce one or defined metrics such as delay and the number of stops based on the projected volume data for example;
Sixth step 560 wherein the TMSS defines a new traffic signal control plan and transmits this to the TMS which implements the new control data within the control plan; and
Seventh step 570 wherein subsequently new connected vehicle data is acquired in order to define metrics that quantify the impact of the adjustments to the traffic light control plan.

Within FIG. 5 this process is depicted as looping so that at a predetermined point in time the process repeats. This may be defined according to a predetermined schedule, e.g. weekly, monthly, quarterly, yearly etc. or based upon a defined quantity of connected vehicle data being acquired. It would be evident that the defined schedule may adjust in dependence upon one or more factors such as planned road maintenance, local construction projects etc. Accordingly., where the traffic signal control plan relates to an area with a new construction project a higher frequency of looping and analysis may be employed to accommodate the short-term traffic changes relative to an established road with no direct infrastructure or local infrastructure activities. For example, the initiation of construction of a new building or the building of a sub-division for roads impacted where subsequent to construction completing the periodicity is reduced in one or more steps of a series of steps.

The TMSS and/or TμS and/or SIMOD may employ one or more of fixed algorithms and/or machine learning (ML) processes. The TMSS and/or TμS and/or SIMOD may be an artificial intelligence system.

It would be evident that the turning movement proportion may be employed to generate an overall flow for a series of roads and/or junctions based upon feeds to the roads. These may be generated from connected vehicle data or derived from other means such as census information, demographic analysis, council records etc.

Whilst the Flow 500 is described with respect to averages it would be evident that additional statistical data may be derived from the connected car data and correlated with the TMSS output such as skewness, standard deviation, etc.

It would be evident that other factors may be established from the connected vehicle data and correlated/employed to optimize the TMSS. These may, for example, relate to speed, overlaps of traffic signal states with bus advance signals etc. These may also include, for example, data from preceding junction, crossroad to the road at a junction, etc.

It would be evident that the TMSS may correlate connected vehicle data with data from a TMS such that, for example, when the connected vehicle data denotes the vehicle as stopped with its location data near a junction the TMS can provide data relating to traffic signals that confirm the state of the traffic signal at that time. Such data may be used to remove extraneous stops from the data that arise from the action of the driver independent of the overall state of the traffic and traffic signals such as stopping to send an electronic message, stopping to drop or pick up a passenger, make a delivery etc.

It would be evident that the TMSS may perform these optimisation for extended periods rather than short spells such as morning peak, mid-morning peak, afternoon peak for example. The defined time period may be morning, afternoon, all day, several days, a week etc. Where a short spells such as morning peak is employed then additional configuration data may define that the morning is a weekday, weekend, summer, winter, school day, school holiday etc.

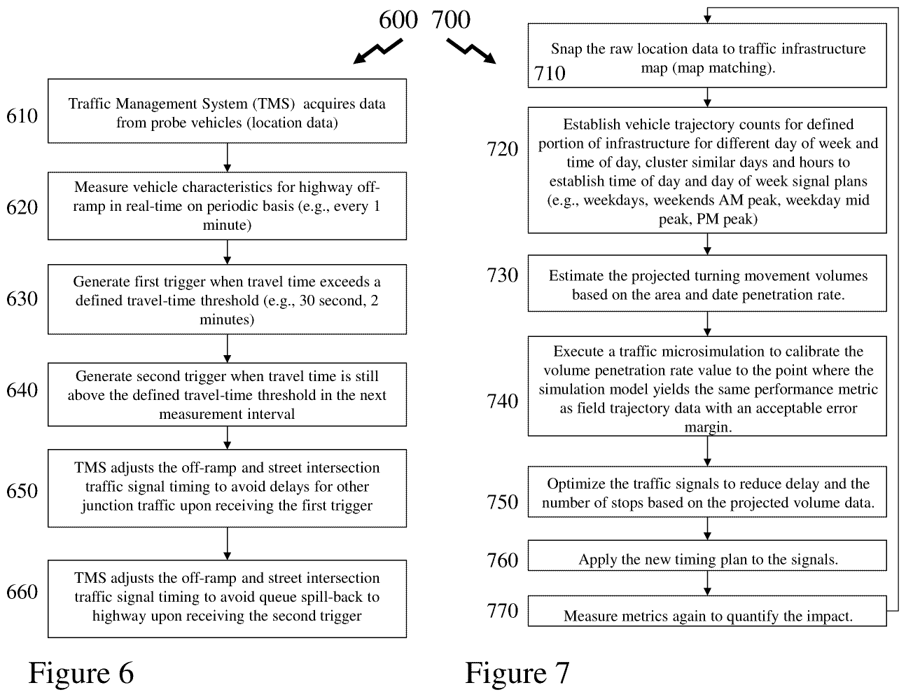

Now referring to FIG. 6 there is depicted an exemplary Flow 600 for a traffic management system (TMS) according to an embodiment of the invention for adjusting traffic signal timing to improve safety and mobility at a highway off-ramp. The TMS may execute an off-ramp queue control using traffic data from probe vehicles, connected vehicles, with a process as depicted in FIG. 6 with Flow 600 comprising first to sixth steps 610 to 660 respectively, these comprising:
First step 610 wherein the Traffic Management System (TMS) acquires data (e.g. location data, velocity, brake setting) from probe vehicles (e.g. connected vehicles);
Second step 620 wherein the TMS establishes from the acquired probe vehicle data a travel time and speed for the probe vehicles on a periodic basis, e.g. every minute;
Third step 630 wherein the TMS determines whether to generate a first trigger when the probe vehicle data indicates a travel time exceeds a defined travel-time threshold (i.e. the traffic is not moving well) where this threshold may for example be 30 seconds, 1 minute, 2 minutes or another value defined in dependence upon one or more characteristics such as junction design, off-ramp length, etc. (the travel time may be established for the probe vehicles from a predetermined location on the highway or off-ramp to one or more other locations associated with points on the road(s) connected to the off-ramp such that the time between these is a travel time to exit the off-ramp and clear it);
Fourth step 640 wherein the TMS determines whether to generate a second trigger when the probe vehicle data indicates the travel time for the probe vehicles still exceeds the defined travel time threshold;
Fifth step 650 wherein the TMS adjusts the off-ramp and street intersection traffic signal timing to avoid delays for other junction traffic upon receiving the first trigger as well moving traffic on the off-ramp indicates it clearing well (for example); and
Sixth step 660 wherein the TMS adjusts the off-ramp and street intersection traffic signal timing to avoid queue spill-back to highway upon receiving the second trigger as excessive time to clear the off-ramp indicates that a backup may subsequently occur onto the highway.

The TMS may signal these changes to the traffic signals at the off-ramp and Junction 300 either through direct communication with them or through an application programming interface (API) to other systems that control the signals, such as an Advanced Traffic Management System (ATMS) etc. Optionally, these triggers can also be communicated to other TMS, ATMS etc. to provide additional data such as allowing the TMS to know that for one off-ramp on the highway the traffic signals for the other side are being adjusted as these adjustments impact the off-ramp where two off-ramps are associated with the same junction.

Whilst FIG. 6 is described and depicted with respect to an off-ramp it would be evident that the methods, processes and concepts may be applied to an on-ramp or other aspect of a portion of a traffic network. In such alternate applications one or more triggers may be generated upon monitored conditions dropping below one or more thresholds rather than exceeding them or a combination of exceeding/dropping below.

Referring to FIG. 7 there is depicted an exemplary flow chart for a traffic management system (TMS) according to an embodiment of the invention for optimizing a traffic simulation and adjusting traffic signal timing accordingly. Accordingly, within FIG. 7 there is depicted a Flow 700 relating to the use of high-resolution connected vehicle location data to retime traffic signals comprising first to seventh steps 710 to 770 respectively, these comprising:
First step 710 wherein a Traffic Management Simulation System (TMSS) processes acquired location data, e.g. raw GPS data, to a traffic infrastructure map, e.g. a map managed by a regulatory authority, council, state, Government organization (e.g. Ordnance Survey in the UK), or a third-party service provider (e.g. OpenStreetMap™, Google™) in order to align the raw location data to the traffic infrastructure (what the inventors refer to as map matching);
Second step 720 wherein for a defined road for a defined time period such as morning peak, mid-morning peak, afternoon peak the TMSS establishes one or more vehicle trajectory counts for a defined portion of network infrastructure (e.g. a road segment, intersection, junction, etc.);
Third step 730 wherein the TMSS generates an estimate of turning movement volumes based on the trajectory counts for the junction (discretely or in combination with historical turning proportion data, etc.);
Fourth step 740 wherein the TMSS executes a TμS to calibrate the volume penetration rate value to the point where the simulation model (SIMOD) yields a performance metric with an acceptable error margin of the field trajectory data defined from the connected vehicle data;
Fifth step 750 wherein the TMSS executes an optimisation process for the control data for traffic signals associated with the defined road to reduce one or defined metrics such as delay and the number of stops based on the projected volume data for example;
Sixth step 760 wherein the TMSS defines a new traffic signal control plan and transmits this to the TMS which implements the new control data within the control plan; and
Seventh step 770 wherein subsequently new connected vehicle data is acquired in order to define metrics that quantify the impact of the adjustments to the traffic light control plan.

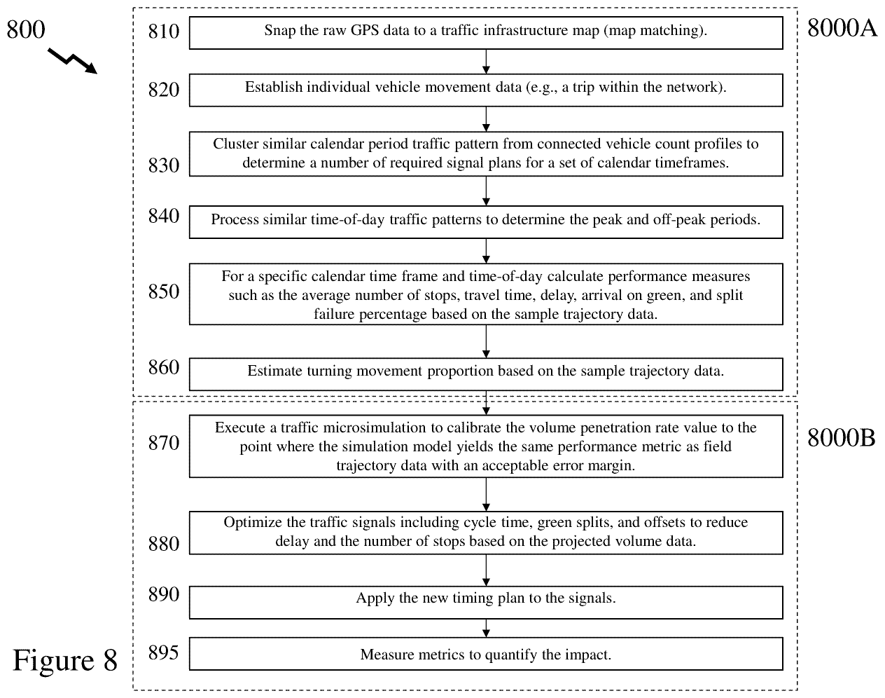

Now referring to FIG. 8 there is depicted Flow 800 for a traffic management system (TMS) according to an embodiment of the invention for optimizing a traffic simulation and adjusting traffic signal timing accordingly. As depicted Flow 800 comprises a first Sub-Flow 8000A comprising first to sixth steps 810 to 860 respectively and second Sub-Flow 8000B. First Sub-Flow 8000A comprising seventh to tenth steps 870 to 895 respectively. Considering first Sub-Flow 8000A then the steps depicted comprise:
First step 810 wherein a Traffic Management Simulation System (TMSS) processes acquired data to extract location data, e.g. raw GPS data, and then processes the location data align the raw location data to a traffic infrastructure map (what the inventors refer to as map matching) where the traffic infrastructure map may be established from, e.g. a map managed by a regulatory authority, council, state, Government organization, etc.
Second step 820 wherein the TMSS establishes within the acquired data an individual vehicle movement data profile for each vehicle of a subset of the vehicles from which or to which the acquired data relates, e.g. for a trip within the traffic network defined by the traffic infrastructure map;
Third step 830 wherein the TMSS clusters the individual vehicle movement data profiles based upon calendar data within the acquired data to establish a cluster for a specific calendar period, e.g. a day, a week, a month, etc. in order to define a number of required signal plans for a set of calendar timeframes within the specific calendar period, for example the specific calendar period and the calendar timeframe may be the same (e.g., a day or 24 hour period) or they may be different (e.g. the specific calendar period is 7 days and each calendar timeframe is a day);
Fourth step 840 wherein the TMSS further processes the clustered data from third step 830 based upon similar time-of-day in order to define peak and off-peak periods wherein these are defined by the TMSS based upon traffic flow relative to a threshold or thresholds;
Fifth step 850 wherein for a specific calendar time frame and time-of-day the TNSS calculates performance measures such as the average number of stops, travel time, delay, arrival on green, and split failure percentage based on the sample trajectory data within the clustered individual vehicle movement data profiles (which may be all of the clustered individual vehicle movement data profiles or a predetermined subset of them); and
Sixth step 860 wherein the TMSS estimates a turning movement proportion based on the sample trajectory data for the junction within the traffic network portion being analysed which could be a single junction, a series of sequential junctions or a series of non-sequential junctions for example.

Considering second Sub-Flow 8000B then the steps depicted comprise:
Seventh step 870 wherein the TMSS employs one or more TμS of the traffic network or a portion of the network such that the volume penetration rate value established by a SIMOD yields a performance metric with an acceptable error margin of the field trajectory data defined from the connected vehicle data from sixth step 860;
Eighth step 880 wherein the TMSS employs an optimisation process for the control data for traffic signals associated with the traffic network or a portion of the network simulated with the SIMOD to reduce one or defined metrics such as delay and the number of stops based on the projected volume data for example;
Ninth step 890 wherein the new TMSS defined traffic signal control plan is transmitted to the TMS which implements the new control data within the control plan for the traffic signal(s) associated with the traffic network or a portion of the network; and
Tenth step 895 wherein the TMSS subsequently acquires further acquired data with a third sub-flow (not depicted for clarity) to establish a series of metrics which are compared with the baseline metrics established in fifth step 850 to quantify the impact of the new traffic signal control plan.

The third sub-flow may, for example, comprise first to fifth steps of first Sub-Flow 8000A.

Optionally, a traffic infrastructure map may be established in dependence upon simply processing the location data within the acquired data from connected vehicles or other data sources associated with vehicles. For example, location data from a plurality of data sets where each data set is associated with a vehicle may be clustered as an element of the traffic infrastructure map when the location data from the plurality of data sets are within a predetermined tolerance of each other. Further, refinement to differentiate different carriageways may be established where the location data from the plurality of data sets is that portion of the location data from the plurality of data sets associated with a specific direction.

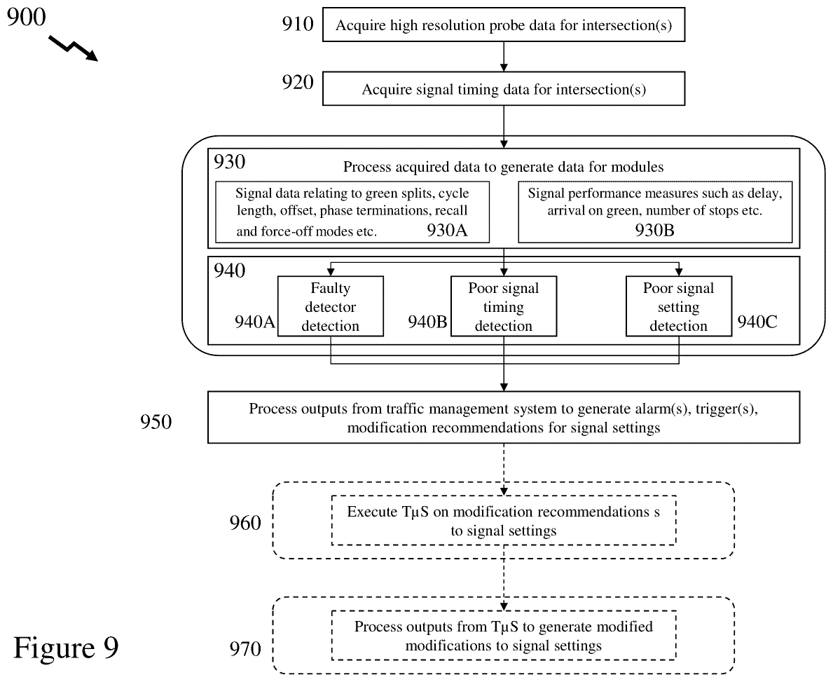

Referring to FIG. 9 there is depicted Flow 900 for a traffic management system (TMS) according to an embodiment of the invention for capturing faulty traffic management detectors and/or sub-poor signal timing settings. As depicted Flow 900 comprises first to seventh steps 90 to 970 respectively. Accordingly, these steps comprise:
First step 910 wherein a TMSS acquires high resolution probe data for a set of intersections within a traffic network or part of a network (see for example first step 810 in FIG. 8 for data acquisition);
Second step 920 wherein the TMSS acquires signal timing data for set of intersections;
Third step 930 wherein the TMSS processes the data from second step 920 to applies conditioning, filters, algorithms, etc. in first and second sub-steps 930A and 930B respectively, comprising:
   First sub-step 930A wherein the TMSS generates signal data relating to one or more aspects of the signals such as green splits, cycle length, offset, phase terminations, recall and force-off modes for example; and
   Second sub-step 930B wherein the TMSS generates signal performance measures such as delay, arrival on green, and number of stops for example;
Fourth step 940 wherein the TMSS applies one or more processing modules, such as first to third Modules 940A-940C respectively, which obtain data from first sub-step 930A and/or second sub-step 930B according to the functionality of the module where these for example are:
   First Module 940A wherein the TMSS establishes whether there is a faulty detector associated with a traffic signal, the detector for example being associated with measuring traffic flow, presence of a vehicle stopped at junction, measuring vehicle speed, absence of a queue etc.
   Second Module 940B wherein the TMSS establishes (detects/determines) whether a junction or junctions has poor signal timing; and
   Third Module 940C wherein the TMSS establishes (detects/determines) whether a junction or junctions has poor signal settings other than timing;
Fifth step 950 wherein the outputs from the modules of fourth step 940, e.g. first to third Modules 940A-940C respectively, are processed to generate one or more of an alarm (e.g. accident or breakdown), an event trigger (e.g. replace faulty detector), or modification recommendations for signal settings, for example.

Flow 900 may comprise further optional steps such as those depicted by sixth and seventh steps 960 and 970 respectively, wherein these comprise:
Sixth step 960 wherein the TMSS executes one or more TμS using the modification recommendations to verify that these lead to an improvement in traffic flow within the traffic network; and
Seventh step 970 wherein the TMSS processes the outputs from the one or more TμS to generate modified modifications to signal settings.

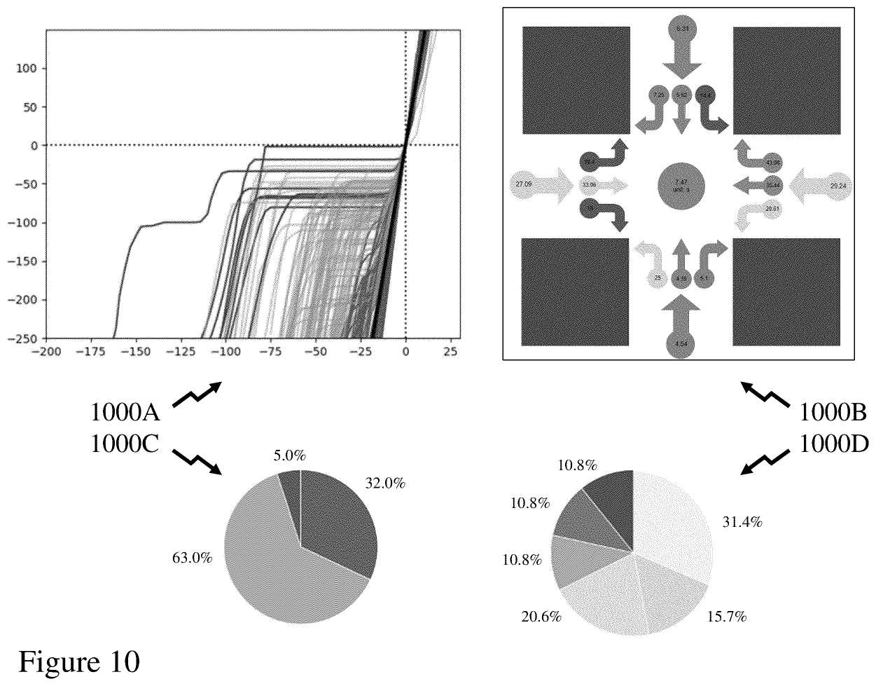

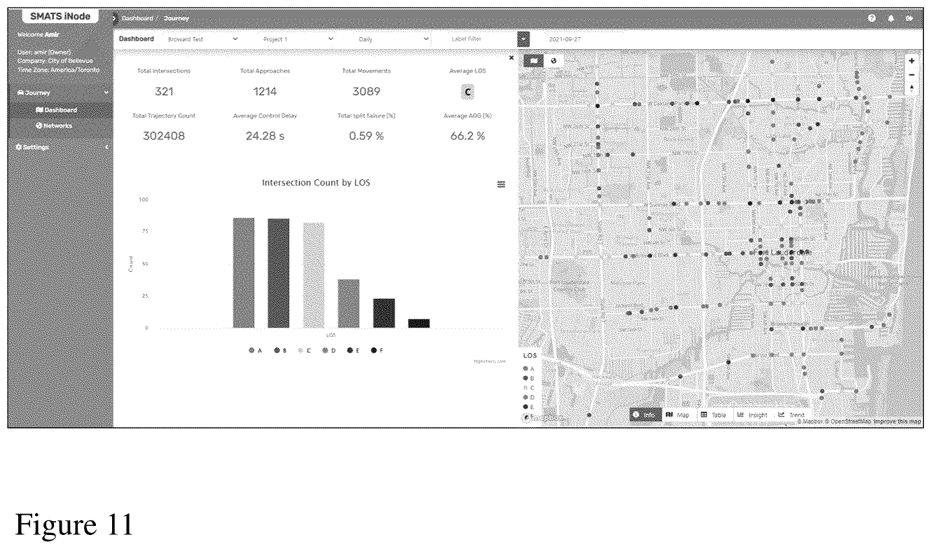

Now referring to FIGS. 10 and 11 there are depicted exemplary analytics from a system according to an embodiment of the invention with respect for traffic intersections controlled by traffic signals using data established from connected vehicles. Referring initially to FIG. 10 there are depicted first to fourth Images 1000A to 1000D respectively. First Image 1000A depicts acquired connected vehicle data for a traffic intersection which plots the distance from a stop bar (e.g., a painted stop line) for the intersection against a time to the far side of the intersection. Accordingly, those plots on the right hand side represent what might be referred to as “smooth” flow where traffic does not sit for substantial periods of time before crossing the intersection. However, those plots increasingly to the left represent an increasing time for a connected vehicle prior to its reaching the far side of the intersection. Accordingly, an objective of adjusting the control pattern for signals associated with the intersection may be to reduce the overall spread of time spent for the connected vehicles prior to their reaching the other side of the intersection rather than simply minimizing, i.e. managing to the standard distribution rather than the mean. However, in other embodiments of the invention the mean and standard distribution are both optimized.

Second image 1000B depicts the path trajectory counts (i.e., straight on as well as turning trajectories) for each of the approaches to an intersection. These are depicted in coded format where the coding is representative of the time a connected vehicle takes to complete an approach to the intersection and leave upon the desired exit. Second Image 1000B is depicted with respect to a single time threshold whereas within other embodiments of the invention different thresholds may be set for a straight-through trajectory, a left turn or a right turn where the traffic control signals are adjusted against these thresholds to lower either the mean time waiting and/or the standard deviation of the time waiting.

Third Image 1000C depicts the percentage of trajectories based upon the number of stops a connected vehicle must make for the intersection within an associated time period after a process of data acquisition, microsimulation model development and optimisation. Accordingly, after optimisation 63% of trajectories at the intersection are completed without a single stop, 32% of the trajectories are executed without a stop, whilst 5% require two stops. Fourth Image 1000D depicts the percentage of trajectories relative to several levels of service, defined as Levels A to F, wherein the percentages at these levels are 31.4%, 15.7%, 20.6%, 10.8%, 10.8% and 10.8% respectively.

For example. Levels A to C may be considered “acceptable” times for straight-through, left-turn and right-turn trajectories respectively whilst Levels D to F are “unacceptable” times for the same trajectories. Accordingly, embodiments of the invention through connected vehicle data acquisition, development of a microsimulation, and optimisation may seek to reduce the percentages of Levels D to F respectively whilst not necessarily minimizing each of Levels A to C respectively. Within other embodiments of the invention optimisation with respect to optimisation emphasis may be placed on specific trajectories and/or specific levels of service.

Within FIG. 11 a graphical user interface (GUI) for a software application forming part of a TMS and/or TMSS is depicted showing the analysis of a series of intersections and approaches, in this instance 321 intersections and 1,214 approaches to the intersections which provide a total of 3,089 movements (trajectories), where the analysis of 302,408 sets of trajectory data (connected vehicles) is depicted where the intersections are colour coded according to their overall level of service (LOS). The LOS may, for example, be an averaged level of service across the movements for an intersection or it may be a weighted average such that emphasis is placed upon particular movements (e.g. straight through, left turn or right turn). Accordingly, the GUI may depict connected vehicle data prior to a simulation—optimisation process or it may present the results of such a simulation—optimisation process during an intermediate point or upon completion.

Optionally, each intersection may be analysed and optimized by a discrete microsimulation or subsets of the intersections may be within a microsimulation or all intersections may be within a single microsimulation. A microsimulation may comprise a series of subsidiary microsimulations. Optionally, the optimisation may place specific emphasis on one or more subsets of the intersections or upon one or more subsets of microsimulations forming the overall simulation for the portion of the traffic network. Accordingly, the optimisation may place particular emphasis on an overall flow rather than specific intersections. For example, a flow into a downtown core weekdays 7 am-9 am may be “prioritised” relative to other routes. Optionally, segments of the portion of the traffic network may be given higher priority for optimisation, e.g. dual carriageways/interstates (motorways, autobahns, etc.), than single lane roads or one-way streets over others etc.

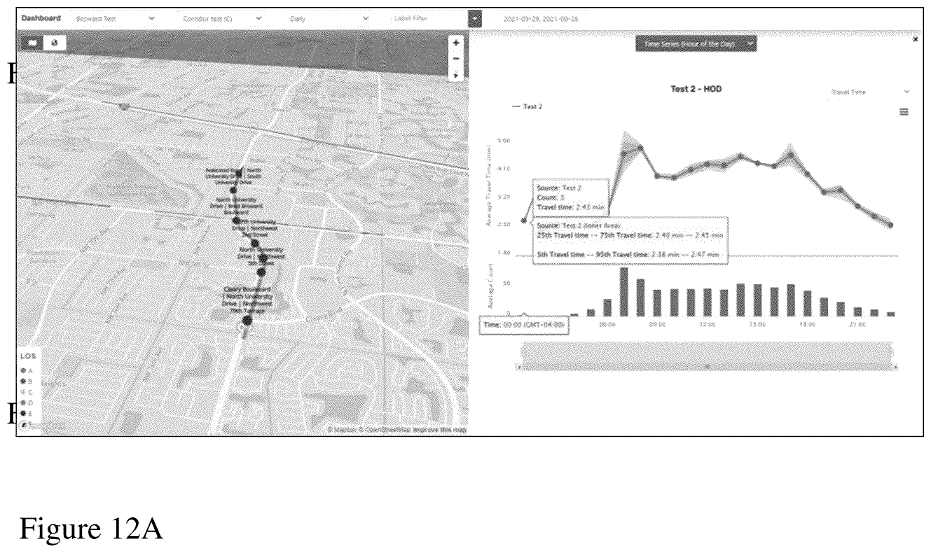

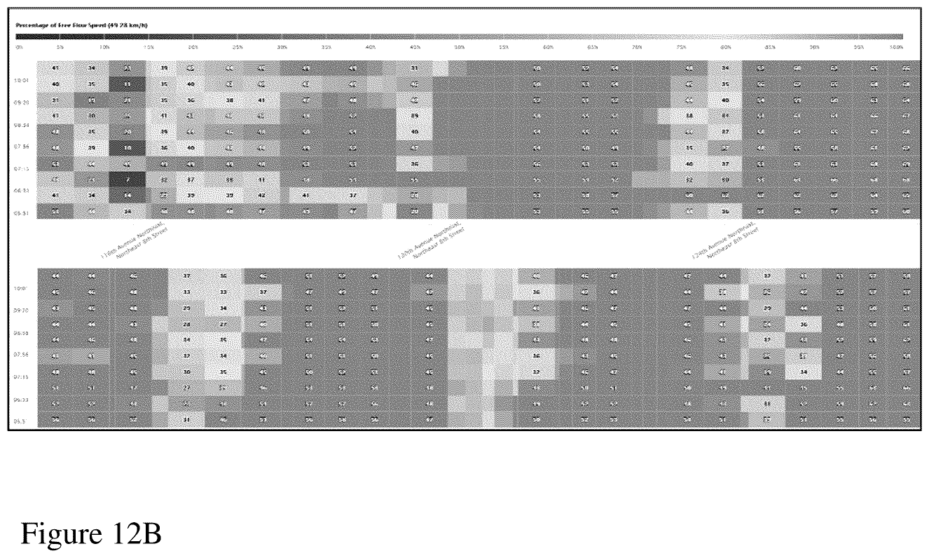

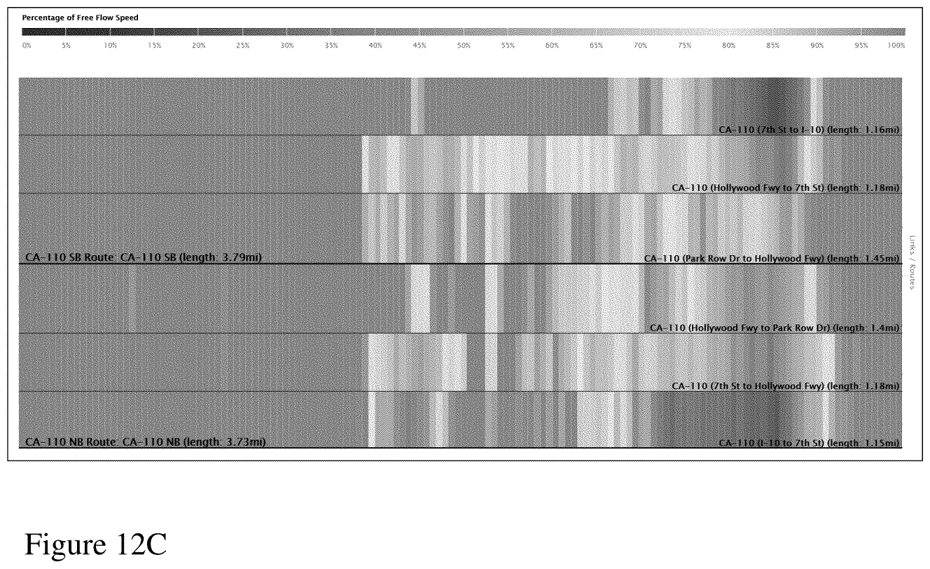

Referring to FIGS. 12A to 12C there are depicted exemplary analytics from a TMS according to an embodiment of the invention with respect for traffic conditions on a traffic corridor using data established from connected vehicles. For example, considering the discussion above with respect to prioritizing portions of the traffic network data may be acquired and employed in a simulation-optimisation process for a portion of the traffic network, referred to herein as a corridor, where the embodiments of the invention may optimise traffic flow along the corridor. A corridor may be a portion of a single road, a single road, a series of roads, or portions of a series of roads. FIG. 12A depicts an analytics GUI presented to a user forming part of a TMS or TMSS according to an embodiment of the invention for a corridor, depicted in the left hand side of the GUI, wherein intersections are colour coded according to their LOS. On the right hand side of the GUI average travel time versus time of day for connected vehicles along the corridor is plotted over a predetermined number of days together with the average count during each hour.

FIGS. 12B and 12C depicted alternate display visualizations within a GUI such as that depicted in FIG. 12A wherein these represent route heatmap visualizations. These may depict average delay, number of stops, average speed, travel time, or travel time reproducibility for example. For example, in FIG. 12B the percentage of free flow speed of the corridor is depicted for different segments of the corridor (horizontal) at different times (vertical). In contrast, in FIG. 12C the heatmap represents the same measure for different time slots over a multitude of routes so that a user can visualize interdependencies of the routes. The simulation-optimisation process may optimize the percentage of free flow speed across all routes rather than upon a single route (corridor).

Accordingly, the simulation—optimisation process based upon processing connected vehicle data may be configured to optimize the traffic signals along the corridor and within a predetermined distance (e.g. physical and/or count) adjacent to the corridor that feed into and out of the corridor. The optimization may be for average transit time and/or distribution of transit time (e.g. 5^{th} to 95^{th} percentile or 25^{th} to 75^{th} percentile for example) so that minimizing the average time does not override the optimization process.

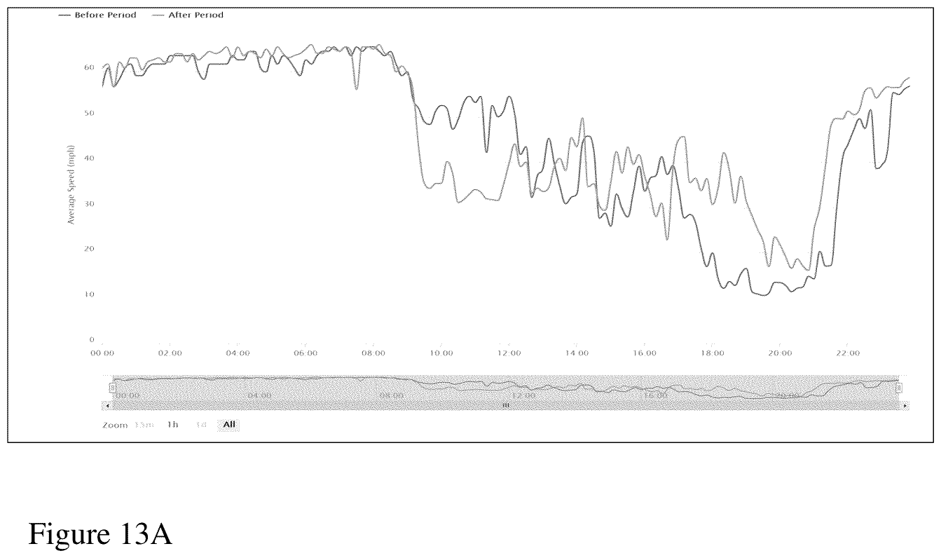

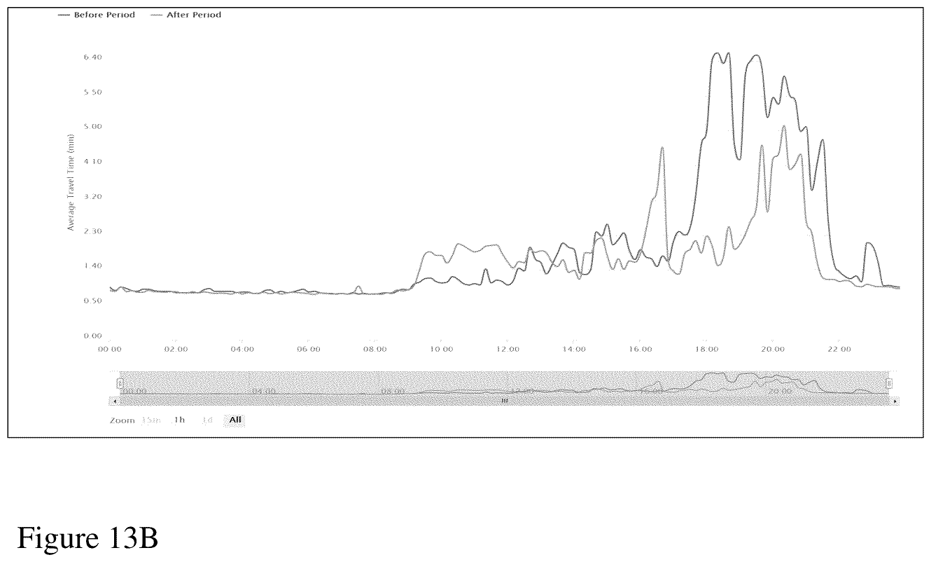

Now referring to FIG. 13A and FIG. 13B there are depicted the impact of adjustments to traffic signals based upon analytics of data established from connected vehicles by a system according to an embodiment of the invention with respect to average speed and average travel time for a route before and after adjustment of traffic signals along the route. FIG. 13A depicts the average speed versus time of day for a portion of the traffic network subject to a simulation—optimisation process before and after the simulation—optimisation process. FIG. 13B depicts the average travel time versus time of day for a portion of the traffic network subject to a simulation—optimisation process before and after the simulation—optimisation process. Accordingly, from the results depicted in FIGS. 13A and 13B the traffic signal re-timing reduces the overall average travel time. Whilst the simulation—optimisation process was performed across the full time period it would be evident that the simulation-optimisation process may comprise multiple simulation—optimisation processes each associated with a different time frame. These time frames may be discrete or they may overlap.

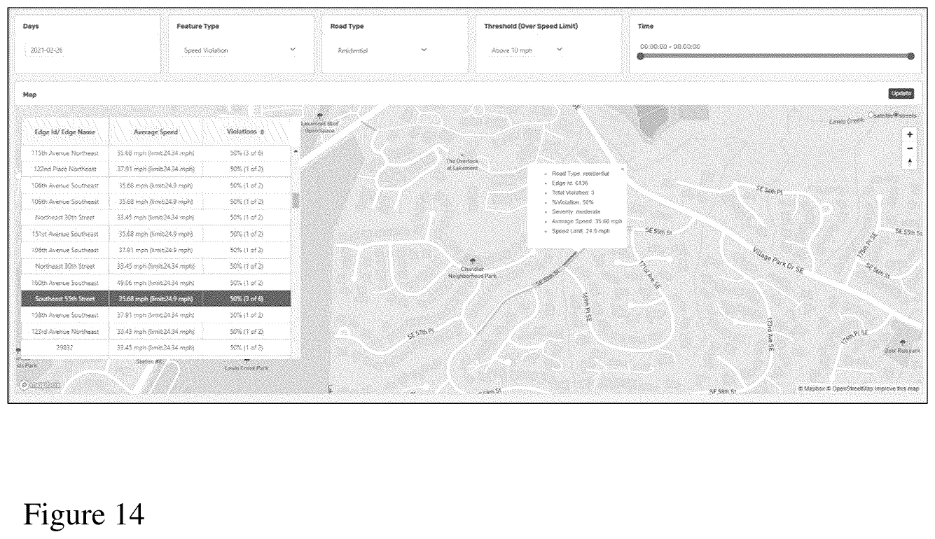

Referring to FIGS. 14 to 16B there are depicted GUIs within a software application according to an embodiment of the invention presented to a user based upon analytics of data established from connected vehicles with respect to connected vehicle actions such as speeding, hard acceleration and hard breaking. The software application may acquire and process connected vehicle data comprising at least location data and at least one of accelerometer data, velocity data and sensor data associated with a sensor forming part of an element of protecting an individual. Such an element being an airbag, automatic braking system (ABS) or traction control for example. Accordingly, the software may process the location and velocity data to establish whether the connected vehicle is speeding relative to the posted speed limit at that location.

It would be evident that within some embodiments of the invention the connected vehicle data is anonymized prior to analysis or transmission by the connected vehicle such that users are encouraged to provide data without fearing that their own data is used against them in respect of traffic infractions etc. where the normal means of police, traffic cameras, etc. provide that enforcement aspect.

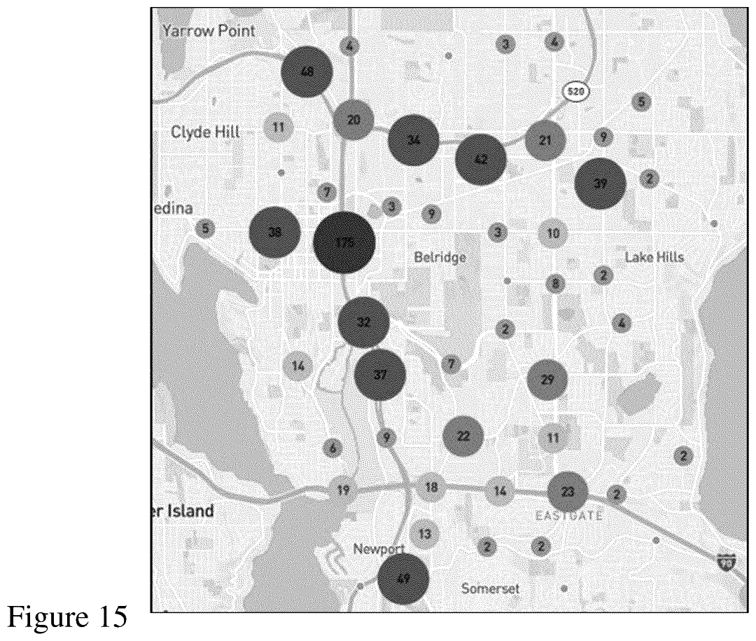

The GUI in FIG. 14 depicts the analysis results with a map interface wherein upon the user selecting an indicated analysis result, e.g. “Southeast 55^{th} Street”, this is rendered within the map interface together with additional data such as number of violations, rate of violation relative to count in time frame, a severity result (e.g. based upon percentage of average violation over speed limit for example), average speed of violations and posted speed limit. Such analysis can indicate “rat runs” which are common cut through routes used to bypass common areas of slow traffic, accidents etc. FIG. 15 depicts a GUI allowing a user to view the violations within different defined portions of the traffic network allowing the user to see a larger perspective.

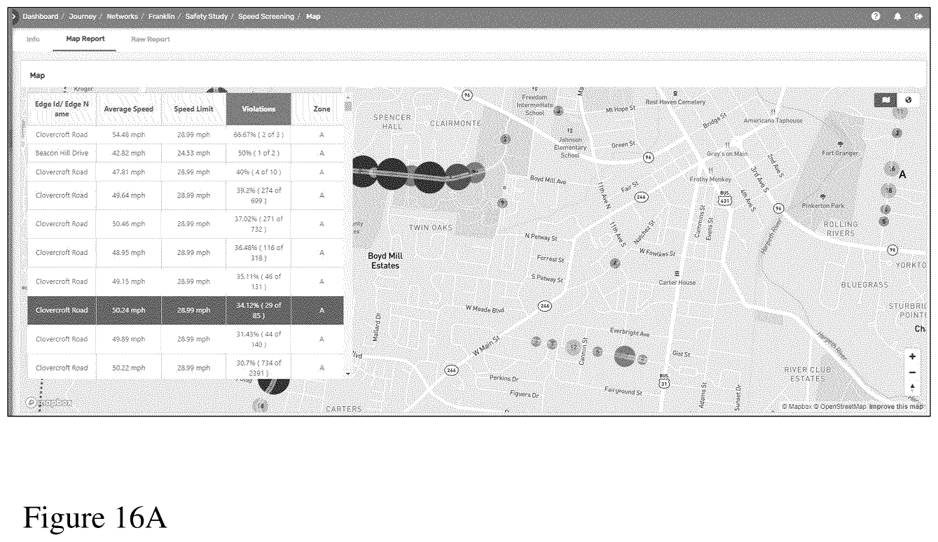

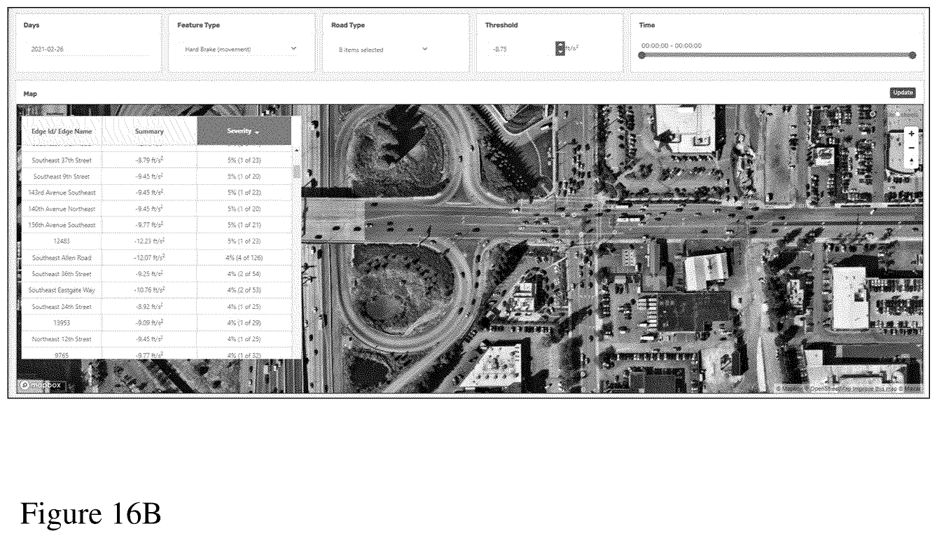

FIG. 16 depicts a similar GUI to that depicted in FIG. 14. FIG. 14 presents the analysis for a road, e.g., “Southeast 55^{th} Street”, whilst within FIG. 16A the results for a street, “Clovercroft Road”, are presented over multiple portions of the street such that a user can visualize whether specific regions of the street are more prone to infractions than others, for example, is speeding more prevalent in some areas or environments than others.

Within other embodiments of the invention the analysis and visualizations may be with respect to other aspects of traffic movement within the region such as hard deceleration, hard acceleration, accidents, loss of traction etc.

For example, a TMS may execute a process wherein it determines that at least one of accelerometer data, velocity data and sensor data establishes an event of a plurality of events associated with a connected vehicle of the plurality of connected vehicles and a time stamp associated with the event of the plurality of events. Accordingly, upon a positive determination of the event the TMS parses the location data within the acquired connected vehicle data having the time stamp with respect to a database comprising data relating to a portion of a road network to establish at least one of a road segment within the road network and the intersection within the road network at which the event occurred.

The TMS then parses the acquired connected vehicle data and other network data associated with the at least one of the road segment within the road network and an intersection within the road network at which an event of the plurality of events occurred to establish a dataset comprising at least one of a volume of traffic associated with the road network and an intersection within the road network at which the event of the plurality of events occurred, a speed of the connected vehicle associated with the event of the plurality of events and a portion of the other network data associated with the event of the plurality of events. In this manner the status of traffic signals etc. can be factored into the analysis. Optionally, other data sets may be integrated including, for example, weather data. Further, the analysis may establish data for other connected vehicles within a predetermined distance of the event and/or a predetermined time of the event. In this manner the connected vehicle data allows analysis of events such as accidents, impacts, locations of hard acceleration, locations of hard deceleration, triggering of ABS, triggering of traction control, airbag triggering, etc.

Within FIG. 16B the GUI the results of analysis of connected vehicle data along a section of a road network is depicted with respect to hard decelerations which exceed a predetermined threshold of deceleration, e.g. −8 ft/s2. The GUI presenting the sections of road, an average deceleration of those exceeding the threshold, and a severity (e.g. a percentage of the connected vehicles exceeding the threshold relative to the number of connected vehicles in the dataset for that portion of the road network). A similar analysis may be undertaken with respect to acceleration although this is not depicted within the figures.

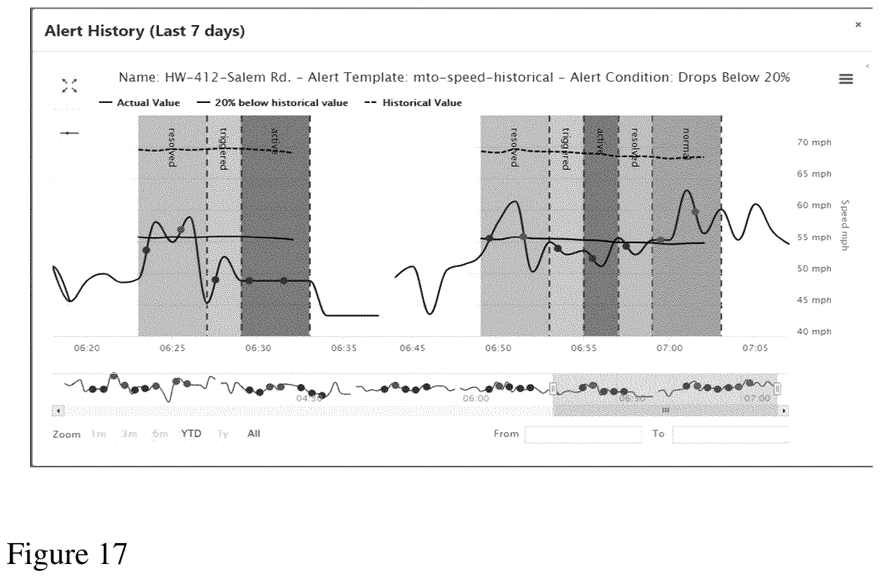

Now referring to FIG. 17 there is depicted analytical data from a system according to an embodiment of the invention with respect to triggering alerts and/or dynamic adjustments for a route exploiting analytics of data established from connected vehicles. In FIG. 17 the connected vehicle speed data is presented over a period of time wherein there is plotted the historical value, the actual values from real time connected vehicles, and an assessment by the TMS as to status of dynamic adjustments in controlling the traffic. Accordingly, a “resolved” period is one where traffic flow is within defined boundary conditions, a “triggered” period is where the conditions are outside the defined boundary conditions and “active” where the TMS is dynamically executing a microsimulation and adjusting control signaling etc. to address the triggering aspect. Accordingly, in FIG. 17 the triggering aspect is a reduction in speed. The two large graphs in FIG. 17 being a zoomed portion of the overall timeline depicted at the bottom of the GUI.

A TMS according to an embodiment of the invention may execute a process or method comprising the steps of:
acquiring connected vehicle location data;
processing the acquired connected vehicle location data to establish one or more performance measures with respect to at least one of a road segment and a traffic junction; and
establishing in dependence upon the performance measures and current traffic signal timing of one or more traffic signals for the at least one of the road segment and the traffic junction a modification to the current traffic signal timing of the one or more traffic signals.

A TMS according to an embodiment of the invention may execute a process or method comprising the steps of:
a) acquiring location data from one or more connected vehicles associated with a highway off-ramp at a defined frequency of acquisition;
b) generating a performance metric in dependence upon the location data where the performance metric is a travel time or a speed;
c) making a first determination as to whether the travel time exceeds a travel time threshold when the performance metric is the travel time
d) making a second determination as to whether the speed exceeds a speed threshold when the performance metric is the speed;
e) generating a trigger in dependence upon the first determination and the second determination;
f) adjusting one or more traffic signals to a new setting from an original setting in dependence upon the trigger;
g) repeating steps (a) to (d) and adjusting the one or more traffic signals from the new setting back to the original setting in dependence upon the trigger not being generated.

A TMS according to an embodiment of the invention may execute a process or method comprising the steps of:
acquiring connected vehicle location data;
processing the acquired connected vehicle location data to establish one or more performance measures with respect to a traffic junction; and
establishing in dependence upon the performance measures at least one of the presence of a faulty detector associated with the traffic junction and a failure in the signal timing settings for the traffic junction.

A TMS according to an embodiment of the invention may execute a process or method comprising the steps of:
acquiring high-resolution connected vehicle location data;
processing the acquired high-resolution connected vehicle location data to establish a performance measure with respect to a traffic signal; wherein
the performance measure is either a first measure relating to an overall performance measure of the traffic signal or a second measure relating to an indication of an improvement with respect to a current overall performance measure of the traffic signal upon establishing a re-timing of the traffic signal.

A TMS according to an embodiment of the invention may execute a process or method comprising the steps of:
a) acquiring location data from one or more connected vehicles associated with a highway ramp and a highway associated with the highway ramp at a defined frequency of acquisition;
b) generating a performance metric in dependence upon the location data where the performance metric is at least one of a ramp travel time and a ramp queue speed;
c) convert the at least one of the travel time and the speed to a queue length for the highway ramp and a traffic density for the highway;
d) adjusting a metering signal rate of one or more traffic signals associated with the highway ramp in dependence upon the traffic density;
c) making a first determination as to whether the ramp travel time exceeds a travel time threshold when the performance metric is the ramp travel time
d) making a second determination as to whether the ramp queue speed exceeds a queue speed threshold when the performance metric is the ramp queue speed;
e) generating a trigger in dependence upon the first determination and the second determination;
f) adjusting one or more other traffic signals associated with the highway ramp to a new setting from an original setting in dependence upon the trigger and iterating the adjustments to return the at least one of a ramp travel time and a ramp queue speed below their respective travel time threshold and travel speed threshold; wherein
the at least one of a travel time and a speed are established for a plurality of segments of a road network comprising the highway ramp;
each segment of the plurality of segments is defined by a portion of the road network from a first location prior to the highway ramp to a second location after the highway ramp;
the ramp travel time is established in dependence upon a time from a third location to a fourth location where the third location and the fourth location are defined with respect to the ramp; and
the ramp queue speed is established in dependence upon an average speed from a fifth location to a sixth location where the fifth location and the sixth location are defined with respect to the ramp.

A TMS according to an embodiment of the invention may execute a process or method comprising the steps of
acquiring connected vehicle data comprises location data and at least one of accelerometer data, velocity data and sensor data associated with a sensor forming part of an element of protecting an individual;
determining when the at least one of the accelerometer data, the velocity data and the sensor data to establish an event of a plurality of events associated with a connected vehicle and a time stamp associated with the event of the plurality of events; and
upon a positive determination of the event parsing the location data within the acquired connected vehicle data having the time stamp with respect to a database comprising data relating to a portion of a road network to establish at least one of a road segment within the road network, an intersection within the road network and a turning movement at another intersection at which the event occurred.

The TMS may further ranking the established at least one of the road segments within the road network, the intersections, the another intersections and the turning movements at which the events of the plurality of events occurred.

A TMS according to an embodiment of the invention may execute a process or method comprising the steps of:
acquiring connected vehicle data comprises location data and at least one of accelerometer data, velocity data and sensor data associated with a sensor forming part of an element of protecting an individual;
determining when the at least one of the accelerometer data, the velocity data and the sensor data to establish an event of a plurality of events associated with a connected vehicle and a time stamp associated with the event of the plurality of events;
upon a positive determination of the event parsing the location data within the acquired connected vehicle data having the time stamp with respect to a database comprising data relating to a portion of a road network to establish at least one of a road segment within the road network, an intersection within the road network and a turning movement at another intersection at which the event occurred;
parsing the acquired connected vehicle data and other network data associated with the at least one of the road segment within the road network and an intersection within the road network at which an event of the plurality of events occurred to establish a dataset comprising at least one of:
   a volume of traffic associated with at least one of the road network, the intersection and the another intersection within the road network at which the event of the plurality of events occurred;
   a speed of the connected vehicle associated with the event of the plurality of events; and
   a portion of the other network data associated with the event of the plurality of events; and
employing the dataset as a training set to at least one of an artificial intelligence process and a machine learning process to establish an event prediction model.

Within embodiments of the invention an event may be an accident, a crash, a failure to stop, a premature entry into the intersection not resulting in an accident but evasive action(s), incorrect turn to exit the intersection (i.e. going wrong-way), or an incorrect path within the intersection. The data from the connected vehicle(s), traffic infrastructure would be parsed in dependence upon the type of event for which the event prediction model relates.

The TMS according to the embodiment of the invention wherein the other network data comprises at least one:
acquired connected vehicle data associated with other connected vehicles associated with the at least one of the road segment within the road network and an intersection within the road network at which an event of the plurality of events occurred within a predetermined time period of the time stamp of the event of the plurality of events; and
network infrastructure data relating to one or more active elements of infrastructure controlling traffic for the at least one of the road segment within the road network and an intersection within the road network at which an event of the plurality of events occurred within a predetermined time period of the time stamp of the event of the plurality of events.

It would be evident that a TMS may, based upon processing acquired data from probe and or connected vehicles establish a one or more overall performance measures of a traffic signal. Further, based upon one or more subsequent analysis the TMS may also establish one or more further measurements relating to potential improvement(s) in the performance measure score of the traffic signal based upon signal re-timing for the traffic signal. This performance measurement improvement may, for example, be established in dependence upon one or more simulations of a TMSS triggered by the TMS. Alternatively, the performance measurement improvement based upon comparing the current traffic signal timing and performance metrics with a database storing other traffic signal timing information and performance metrics for these other traffic signal timing information.

Accordingly, a TMS may execute a method comprising an initial step of acquiring high-resolution connected vehicle location data which is then processed to establish a performance measure with respect to a traffic signal. The performance measure may, for example, be a first measure relating to an overall performance measure of the traffic signal. The performance measure may, for example, a second measure relating to an indication of an improvement with respect to a current overall performance measure of the traffic signal upon establishing a re-timing of the traffic signal. The second measure may be established in dependence upon one or more TμS performed by a TMSS under the direction of the TMS or it may be an analysis performed upon a database storing other traffic signal timing information for this traffic signal and/or other traffic signals and overall performance measures for these other timing signal timing datasets.

Whilst within embodiments of the invention the database may be established in dependence upon the TMS and/or other TMS performing analysis upon connected vehicle and/or probe vehicle data it would be evident that other sources of vehicle data and traffic signal performing may be employed as known in the art.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
acquiring connected vehicle data; and
executing a process upon one or more systems, each system comprising at least a microprocessor and performing at least one of analysis of the acquired connected vehicle data and an action in dependence upon the analysis of the acquired connected vehicle data.

2. The method according to claim 1, wherein
the acquired connected vehicle data comprises at least location data; and
the process comprises:
processing the acquired connected vehicle location data to establish one or more performance measures with respect to at least one of a road segment and a traffic junction; and
establishing in dependence upon the performance measures and current traffic signal timing of one or more traffic signals for the at least one of the road segment and the traffic junction a modification to the current traffic signal timing of the one or more traffic signals.

3. The method according to claim 1, wherein
the acquired connected vehicle data comprises at least location data; and
the process comprises:
a) parsing the location data relating to one or more connected vehicles associated with a highway off-ramp at a defined frequency of acquisition;
b) generating a performance metric in dependence upon the location data where the performance metric is a travel time or a speed;
c) making a first determination as to whether the travel time exceeds a travel time threshold when the performance metric is the travel time
d) making a second determination as to whether the speed exceeds a speed threshold when the performance metric is the speed;
e) generating a trigger in dependence upon the first determination and the second determination;
f) adjusting one or more traffic signals to a new setting from an original setting in dependence upon the trigger;
g) repeating steps (a) to (d) and adjusting the one or more traffic signals from the new setting back to the original setting in dependence upon the trigger not being generated.

4. The method according to claim 1, wherein
the acquired connected vehicle data comprises at least location data; and
the process comprises:
processing the acquired connected vehicle location data to establish one or more performance measures with respect to a traffic junction; and
establishing in dependence upon the performance measures at least one of the presence of a faulty detector associated with the traffic junction and a failure in the signal timing settings for the traffic junction.

5. The method according to claim 1, wherein
the acquired connected vehicle data comprises at least location data;
the process comprises:
processing the acquired connected vehicle location data to establish a performance measure with respect to a traffic signal; and
the performance measure is either:
a first measure relating to an overall performance measure of the traffic signal; or
a second measure relating to an indication of an improvement with respect to a current overall performance measure of the traffic signal upon establishing a re-timing of the traffic signal.

6. The method according to claim 1, wherein
the acquired connected vehicle data comprises at least location data; and
the process comprises:
a) parsing the acquired location data to establish location data relating to one or more connected vehicles associated with a highway ramp and a highway associated with the highway ramp at a defined frequency of acquisition;
b) generating a performance metric in dependence upon the location data where the performance metric is at least one of a ramp travel time and a ramp queue speed;
c) convert the at least one of the travel time and the speed to a queue length for the highway ramp and a traffic density for the highway;
d) adjusting a metering signal rate of one or more traffic signals associated with the highway ramp in dependence upon the traffic density;
c) making a first determination as to whether the ramp travel time exceeds a travel time threshold when the performance metric is the ramp travel time d) making a second determination as to whether the ramp queue speed exceeds a queue speed threshold when the performance metric is the ramp queue speed;
e) generating a trigger in dependence upon the first determination and the second determination;
f) adjusting one or more other traffic signals associated with the highway ramp to a new setting from an original setting in dependence upon the trigger and iterating the adjustments to return the at least one of a ramp travel time and a ramp queue speed below their respective travel time threshold and travel speed threshold;
the at least one of a travel time and a speed are established for a plurality of segments of a road network comprising the highway ramp;
each segment of the plurality of segments is defined by a portion of the road network from a first location prior to the highway ramp to a second location after the highway ramp;
the ramp travel time is established in dependence upon a time from a third location to a fourth location where the third location and the fourth location are defined with respect to the ramp; and
the ramp queue speed is established in dependence upon an average speed from a fifth location to a sixth location where the fifth location and the sixth location are defined with respect to the ramp.

7. The method according to claim 1, wherein
the acquired connected vehicle data comprises location data and at least one of accelerometer data, velocity data and sensor data associated with a sensor forming part of an element of protecting an individual; and
the process comprises:
determining when the at least one of the accelerometer data, the velocity data and the sensor data to establish an event of a plurality of events associated with a connected vehicle and a time stamp associated with the event of the plurality of events; and
upon a positive determination of the event parsing the location data within the acquired connected vehicle data having the time stamp with respect to a database comprising data relating to a portion of a road network to establish at least one of a road segment within the road network, an intersection within the road network and a movement with respect to another intersection at which the event occurred.

8. The method according to claim 7, wherein
the method further comprises:
ranking the established at least one of the road segments within the road network, the intersections, the another intersections and the turning movements for the events of the plurality of events occurred.

9. The method according to claim 1, wherein
the acquired connected vehicle data comprises location data and at least one of accelerometer data, velocity data and sensor data associated with a sensor forming part of an element of protecting an individual; and
the process comprises:
determining when the at least one of the accelerometer data, the velocity data and the sensor data to establish an event of a plurality of events associated with a connected vehicle and a time stamp associated with the event of the plurality of events;
upon a positive determination of the event parsing the location data within the acquired connected vehicle data having the time stamp with respect to a database comprising data relating to a portion of a road network to establish at least one of a road segment within the road network and an intersection within the road network at which the event occurred;
parsing the acquired connected vehicle data and other network data associated with the at least one of the road segment within the road network and an intersection within the road network at which an event of the plurality of events occurred to establish a dataset comprising at least one of:
a volume of traffic associated with the road segment within the road network, an intersection within the road network and a turning movement at another intersection at which the event of the plurality of events occurred;
a speed of the connected vehicle associated with the event of the plurality of events; and
a portion of the other network data associated with the event of the plurality of events; and
employing the dataset as a training set to at least one of an artificial intelligence process and a machine learning process to establish an event prediction model.

10. The method according to claim 9, wherein
the other network data comprises at least one:
acquired connected vehicle data associated with other connected vehicles associated with the at least one of the road segment within the road network and an intersection within the road network at which an event of the plurality of events occurred within a predetermined time period of the time stamp of the event of the plurality of events; and
network infrastructure data relating to one or more active elements of infrastructure controlling traffic for the at least one of the road segment within the road network and an intersection within the road network at which an event of the plurality of events occurred within a predetermined time period of the time stamp of the event of the plurality of events.
